(19) United States
(12) Patent Application Publication
(10) Pub. No.: US 2013/0100819 A1
(43) Pub. Date: Apr. 25, 2013

(54) SELECTIVELY ACQUIRING AND ADVERTISING A CONNECTION BETWEEN A USER EQUIPMENT AND A WIRELESS LOCAL AREA NETWORK

(71) Applicants: Kirankumar ANCHAN, San Diego, CA (US); Beth A. BREWER, San Diego, CA (US)

(72) Inventors: Kirankumar ANCHAN, San Diego, CA (US); Beth A. BREWER, San Diego, CA (US)

(73) Assignee: QUALCOMM INCORPORATED, San Diego, CA (US)

(21) Appl. No.: 13/276,831

(22) Filed: Oct. 19, 2011

(51) Int. Cl. H04W 84/02; H04W 24/00

(52) U.S. Cl. 370/241; 370/338

(57) ABSTRACT

In an embodiment, a UE transmits information regarding its local environment to a WWAN-based application server. The application server generates a list of WLAN APs that are in a vicinity of the UE based on the local environment information. The application server sends, to the UE, WLAN AP selection assistance information (SAI) that includes at least the list of WLAN APs and (ii) navigation information by which the UE can navigate to the listed WLAN APs. The UE receives the SAI and provides a user of the UE with directions to a selected WLAN AP based on the SAI. In another embodiment, a communication entity advertises a UE's connection to a WLAN AP along with information related to an estimated duration of the UE's connection. Another communication entity receives the connection advertisement and determines whether to transmit data to the UE based on the advertisement.

### BACKGROUND OF THE INVENTION

1. Field of the Invention

Embodiments of the invention relate to selectively acquiring and advertising a connection between a user equipment (UE) and a wireless local area network (WLAN).

2. Description of the Related Art

Wireless communication systems have developed through various generations, including a first-generation analog wireless phone service (1G), a second-generation (2G) digital wireless phone service (including interim 2.5G and 2.75G networks) and a third-generation (3G) high speed data/Internet-capable wireless service. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, and newer hybrid digital communication systems using both TDMA and CDMA technologies.

The method for providing CDMA mobile communications was standardized in the United States by the Telecommunications Industry Association/Electronic Industries Association in TIA/EIA/IS-95-A entitled “Mobile Station-Base Station Compatibility Standard for Dual-Mode Wideband Spread Spectrum Cellular System,” referred to herein as IS-95. Combined AMPS & CDMA systems are described in TIA/EIA Standard IS-98. Other communications systems are described in the IMT-2000/UM, or International Mobile Telecommunications System 2000/Universal Mobile Telecommunications System, standards covering what are referred to as wideband CDMA (W-CDMA), CDMA2000 (such as CDMA2000 1xEV-DO standards, for example) or TD-SCDMA.

In W-CDMA wireless communication systems, user equipments (UEs) receive signals from fixed position Node Bs (also referred to as cell sites or cells) that support communication links or service within particular geographic regions adjacent to or surrounding the base stations. Node Bs provide entry points to an access network (AN)/radio access network (RAN), which is generally a packet data network using standard Internet Engineering Task Force (IETF) based protocols that support methods for differentiating traffic based on Quality of Service (QoS) requirements. Therefore, the Node Bs generally interact with UEs through an over the air interface and with the RAN through Internet Protocol (IP) network data packets.

In wireless telecommunication systems, Push-to-talk (PTT) capabilities are becoming popular with service sectors and consumers. PTT can support a “dispatch” voice service that operates over standard commercial wireless infrastructures, such as W-CDMA, CDMA, FDMA, TDMA, GSM, etc. In a dispatch model, communication between endpoints (e.g., UEs) occurs within virtual groups, wherein the voice of one “talker” is transmitted to one or more “listeners.” A single instance of this type of communication is commonly referred to as a dispatch call, or simply a PTT call. A PTT call is an instantiation of a group, which defines the characteristics of a call. A group in essence is defined by a member list and associated information, such as group name or group identification.

### SUMMARY

In an embodiment, a UE transmits information regarding its local environment to a WWAN-based application server. The application server generates a list of WLAN APs that are in a vicinity of the UE based on the local environment information. The application server sends, to the UE, WLAN AP selection assistance information (SAI) that includes at least the list of WLAN APs and (ii) navigation information by which the UE can navigate to the listed WLAN APs. The UE receives the SAI and provides a user of the UE with directions to a selected WLAN AP based on the SAI. In another embodiment, a communication entity advertises a UE's connection to a WLAN AP along with information related to an estimated duration of the UE's connection. Another communication entity receives the connection advertisement and determines whether to transmit data to the UE based on the advertisement.

### BRIEF DESCRIPTION OF THE DRAWINGS

A more complete appreciation of embodiments of the invention and many of the attendant advantages thereof will be readily obtained as the same becomes better understood by reference to the following detailed description when considered in connection with the accompanying drawings which are presented solely for illustration and not limitation of the invention, and in which:

FIG. 1 is a diagram of a wireless network architecture that supports access terminals and access networks in accordance with at least one embodiment of the invention.

FIG. 2A illustrates the core network of FIG. 1 according to an embodiment of the present invention.

FIG. 2B illustrates a core network according to another embodiment of the present invention.

FIG. 2C illustrates an example of the wireless communications system of FIG. 1 in more detail.

FIG. 3 is an illustration of a user equipment (UE) in accordance with at least one embodiment of the invention.

FIG. 4 illustrates the wireless communication system of FIG. 1 in accordance with another embodiment of the invention.

FIG. 5A illustrates a process of establishing a connection to a given Wireless Local Area Network (WLAN) Access Point (AP) based on WLAN AP selection assistance information and then advertising the connection in accordance with an embodiment of the invention.

FIG. 5B illustrates a more detailed implementation example of the process of FIG. 5A in accordance with an embodiment of the invention.

FIG. 5C illustrates an example implementation of a portion of FIG. 5A in accordance with an embodiment of the invention.

FIG. 5D illustrates an example implementation of a portion of FIG. 5A in accordance with another embodiment of the invention.

FIG. 5E illustrates a process of establishing a connection to a given WLAN AP based on WLAN AP selection assistance information and then advertising the connection in accordance with another embodiment of the invention.

FIG. 6A illustrates a process of responding to an advertisement of a UE's WLAN AP connection in accordance with an embodiment of the invention.

FIG. 6B illustrates a process of responding to an advertisement of a UE's WLAN AP connection in accordance with another embodiment of the invention.

FIG. 6C illustrates a process of responding to an advertisement of a UE's WLAN AP connection in accordance with another embodiment of the invention.

FIG. 7A illustrates a process whereby the procedures of any of FIGS. 5A through 5E are triggered in response to a mobile-originated large file transfer in accordance with an embodiment of the invention.

FIG. 7B illustrates a process whereby the procedures of any of FIGS. 5A through 5E are triggered in response to a mobile-terminated large file transfer that originates from another UE in accordance with an embodiment of the invention.

FIG. 7C illustrates a process whereby the procedures of any of FIGS. 5A through 5E are triggered in response to a server-originated large file transfer in accordance with an embodiment of the invention.

FIG. 8A illustrates a process of recovering from WLAN coverage loss at a UE in accordance with an embodiment of the invention.

FIG. 8B illustrates a process of recovering from WLAN coverage degradation at a UE in accordance with an embodiment of the invention.

FIGS. 9A and 9B each illustrate a different NAT and/or firewall traversal procedures in accordance with embodiments of the invention.

FIG. 10 illustrates a communication device 1000 that includes logic configured to perform functionality in accordance with an embodiment of the invention.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A High Data Rate (HDR) subscriber station, referred to herein as user equipment (UE), may be mobile or stationary, and may communicate with one or more access points (APs), which may be referred to as Node Bs. A UE transmits and receives data packets through one or more of the Node Bs to a Radio Network Controller (RNC). The Node Bs and RNC are parts of a network called a radio access network (RAN). A radio access network can transport voice and data packets between multiple access terminals.

The radio access network may be further connected to additional networks outside the radio access network, such core network including specific carrier related servers and devices and connectivity to other networks such as a corporate intranet, the Internet, public switched telephone network (PSTN), a Serving General Packet Radio Services (GPRS) Support Node (SGSN), a Gateway GPRS Support Node (GGSN), and may transport voice and data packets between each UE and such networks. A UE that has established an active traffic channel connection with one or more Node Bs may be referred to as an active UE, and can be referred to as being in a traffic state. A UE that is in the process of establishing an active traffic channel (TCH) connection with one or more Node Bs can be referred to as being in a connection setup state. A UE may be any data device that communicates through a wireless channel or through a wired channel. A UE may further be any of a number of types of devices including but not limited to PC card, compact flash device, external or internal modem, or wireless or wireline phone. The communication link through which the UE sends signals to the Node B(s) is called an uplink channel (e.g., a reverse traffic channel, a control channel, an access channel, etc.). The communication link through which Node B(s) send signals to a UE is called a downlink channel (e.g., a paging channel, a control channel, a broadcast channel, a forward traffic channel, etc.). As used herein the term traffic channel (TCH) can refer to either an uplink/reverse or downlink/forward traffic channel.

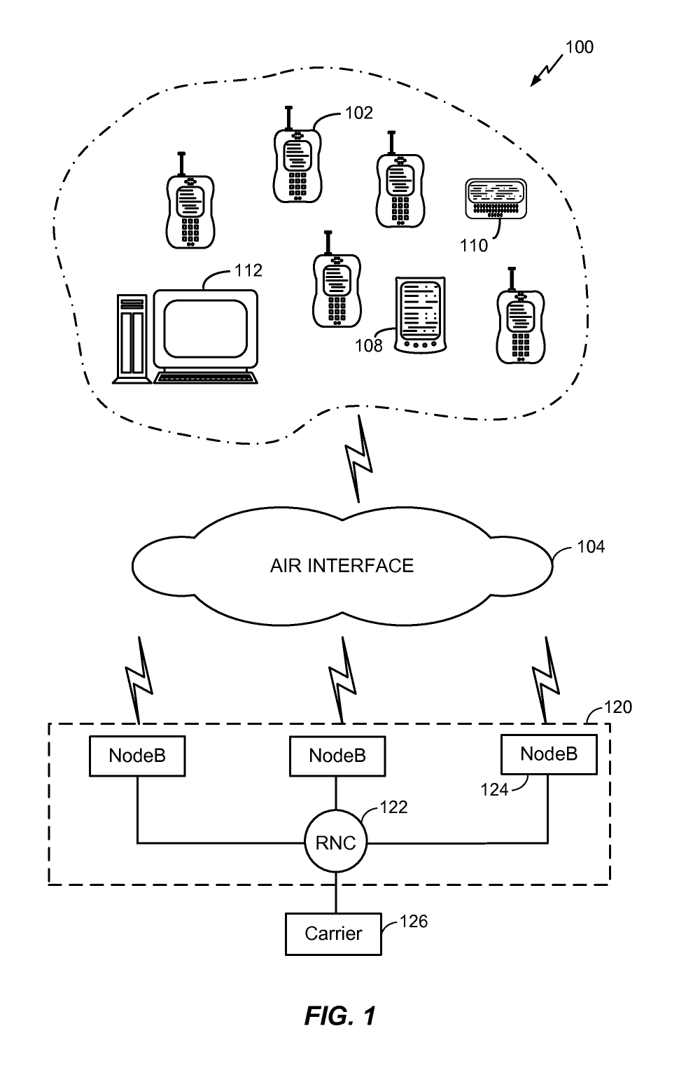

FIG. 1 illustrates a block diagram of one exemplary embodiment of a wireless communications system 100 in accordance with at least one embodiment of the invention. System 100 can contain UEs, such as cellular telephone 102, in communication across an air interface 104 with an access network or radio access network (RAN) 120 that can connect the UE 102 to network equipment providing data connectivity between a packet switched data network (e.g., an intranet, the Internet, and/or core network 126) and the UEs 102, 108, 110, 112. As shown here, the UE can be a cellular telephone 102, a personal digital assistant 108, a pager 110, which is shown here as a two-way text pager, or even a separate computer platform 112 that has a wireless communication portal. Embodiments of the invention can thus be realized on any form of UE including a wireless communication portal or having wireless communication capabilities, including without limitation, wireless modems, PCMCIA cards, personal computers, telephones, or any combination or sub-combination thereof. Further, as used herein, the term “UE” in other communication protocols (i.e., other than W-CDMA) may be referred to interchangeably as an “access terminal”, “AT”, “wireless device”, “client device”, “mobile terminal”, “mobile station” and variations thereof.

Referring back to FIG. 1, the components of the wireless communications system 100 and interrelation of the elements of the exemplary embodiments of the invention are not limited to the configuration illustrated. System 100 is merely exemplary and can include any system that allows remote UEs, such as wireless client computing devices 102, 108, 110, 112 to communicate over-the-air between and among each other and/or between and among components connected via the air interface 104 and RAN 120, including, without limitation, core network 126, the Internet, PSTN, SGSN, GGSN and/or other remote servers.

The RAN 120 controls messages (typically sent as data packets) sent to a RNC 122. The RNC 122 is responsible for signaling, establishing, and tearing down bearer channels (i.e., data channels) between a Serving General Packet Radio Services (GPRS) Support Node (SGSN) and the UEs 102/108/110/112. If link layer encryption is enabled, the RNC 122 also encrypts the content before forwarding it over the air interface 104. The function of the RNC 122 is well-known in the art and will not be discussed further for the sake of brevity. The core network 126 may communicate with the RNC 122 by a network, the Internet and/or a public switched telephone network (PSTN). Alternatively, the RNC 122 may connect directly to the Internet or external network. Typically, the network or Internet connection between the core network 126 and the RNC 122 transfers data, and the PSTN transfers voice information. The RNC 122 can be connected to multiple Node Bs 124. In a similar manner to the core network 126, the RNC 122 is typically connected to the Node Bs 124 by a network, the Internet and/or PSTN for data transfer and/or voice information. The Node Bs 124 can broadcast data messages wirelessly to the UEs, such as cellular telephone 102. The Node Bs 124, RNC 122 and other components may form the RAN 120, as is known in the art. However, alternate configurations may also be used and the invention is not limited to the configuration illustrated. For example, in another embodiment the functionality of the RNC 122 and one or more of the Node Bs 124 may be collapsed into a single “hybrid” module having the functionality of both the RNC 122 and the Node B(s) 124.

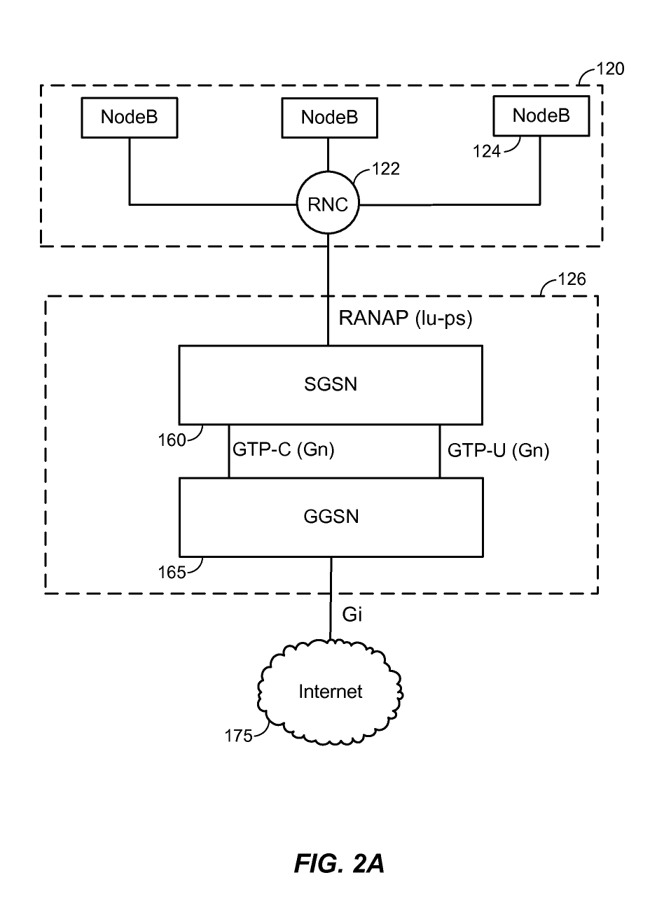

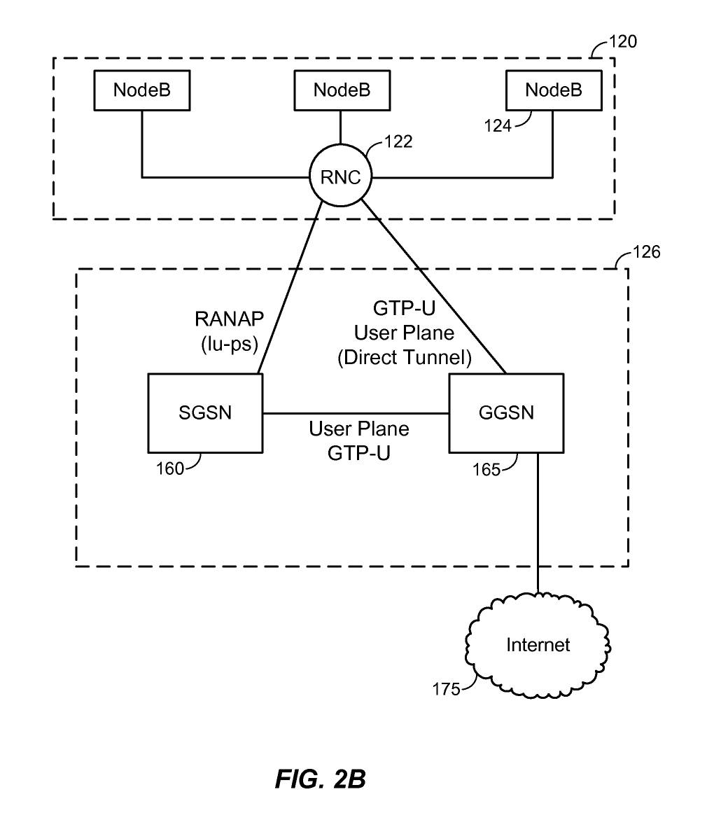

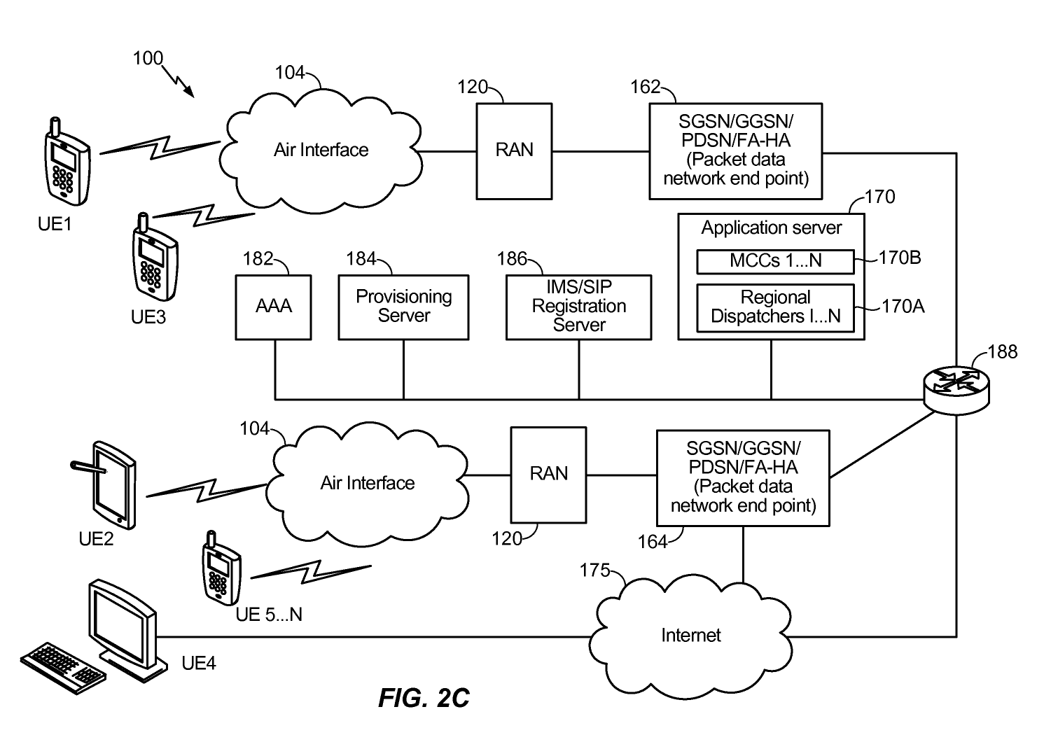

FIG. 2A illustrates the core network 126 according to an embodiment of the present invention. In particular, FIG. 2A illustrates components of a General Packet Radio Services (GPRS) core network implemented within a W-CDMA system. In the embodiment of FIG. 2A, the core network 126 includes a Serving GPRS Support Node (SGSN) 160, a Gateway GPRS Support Node (GGSN) 165 and an Internet 175. However, it is appreciated that portions of the Internet 175 and/or other components may be located outside the core network in alternative embodiments.

Generally, GPRS is a protocol used by Global System for Mobile communications (GSM) phones for transmitting Internet Protocol (IP) packets. The GPRS Core Network (e.g., the GGSN 165 and one or more SGSNs 160) is the centralized part of the GPRS system and also provides support for W-CDMA based 3G networks. The GPRS core network is an integrated part of the GSM core network, provides mobility management, session management and transport for IP packet services in GSM and W-CDMA networks.

The GPRS Tunneling Protocol (GTP) is the defining IP protocol of the GPRS core network. The GTP is the protocol which allows end users (e.g., UEs) of a GSM or W-CDMA network to move from place to place while continuing to connect to the internet as if from one location at the GGSN 165. This is achieved transferring the subscriber's data from the subscriber's current SGSN 160 to the GGSN 165, which is handling the subscriber's session.

Three forms of GTP are used by the GPRS core network; namely, (i) GTP-U, (ii) GTP-C and (iii) GTP′ (GTP Prime). GTP-U is used for transfer of user data in separated tunnels for each packet data protocol (PDP) context. GTP-C is used for control signaling (e.g., setup and deletion of PDP contexts, verification of GSN reach-ability, updates or modifications such as when a subscriber moves from one SGSN to another, etc.). GTP′ is used for transfer of charging data from GSNs to a charging function.

Referring to FIG. 2A, the GGSN 165 acts as an interface between the GPRS backbone network (not shown) and the external packet data network 175. The GGSN 165 extracts the packet data with associated packet data protocol (PDP) format (e.g., IP or PPP) from the GPRS packets coming from the SGSN 160, and sends the packets out on a corresponding packet data network. In the other direction, the incoming data packets are directed by the GGSN 165 to the SGSN 160 which manages and controls the Radio Access Bearer (RAB) of the destination UE served by the RAN 120. Thereby, the GGSN 165 stores the current SGSN address of the target UE and his/her profile in its location register (e.g., within a PDP context). The GGSN is responsible for IP address assignment and is the default router for the connected UE. The GGSN also performs authentication and charging functions.

The SGSN 160 is representative of one of many SGSNs within the core network 126, in an example. Each SGSN is responsible for the delivery of data packets from and to the UEs within an associated geographical service area. The tasks of the SGSN 160 includes packet routing and transfer, mobility management (e.g., attach/detach and location management), logical link management, and authentication and charging functions. The location register of the SGSN stores location information (e.g., current cell, current VLR) and user profiles (e.g., IMSI, PDP address(es) used in the packet data network) of all GPRS users registered with the SGSN 160, for example, within one or more PDP contexts for each user or UE. Thus, SGSNs are responsible for (i) de-tunneling downlink GTP packets from the GGSN 165, (ii) uplink tunnel IP packets toward the GGSN 165, (iii) carrying out mobility management as UEs move between SGSN service areas and (iv) billing mobile subscribers. As will be appreciated by one of ordinary skill in the art, aside from (i)-(iv), SGSNs configured for GSM/EDGE networks have slightly different functionality as compared to SGSNs configured for W-CDMA networks.

The RAN 120 (e.g., or UTRAN, in Universal Mobile Telecommunications System (UMTS) system architecture) communicates with the SGSN 160 via a Radio Access Network Application Part (RANAP) protocol. RANAP operates over a Iu interface (Iu-ps), with a transmission protocol such as Frame Relay or IP. The SGSN 160 communicates with the GGSN 165 via a Gn interface, which is an IP-based interface between SGSN 160 and other SGSNs (not shown) and internal GGSNs, and uses the GTP protocol defined above (e.g., GTP-U, GTP-C, GTP′, etc.). In the embodiment of FIG. 2A, the Gn between the SGSN 160 and the GGSN 165 carries both the GTP-C and the GTP-U. While not shown in FIG. 2A, the Gn interface is also used by the Domain Name System (DNS). The GGSN 165 is connected to a Public Data Network (PDN) (not shown), and in turn to the Internet 175, via a Gi interface with IP protocols either directly or through a Wireless Application Protocol (WAP) gateway.

FIG. 2B illustrates the core network 126 according to another embodiment of the present invention. FIG. 2B is similar to FIG. 2A except that FIG. 2B illustrates an implementation of direct tunnel functionality.

Direct Tunnel is an optional function in Iu mode that allows the SGSN 160 to establish a direct user plane tunnel, GTP-U, between RAN and GGSN within the Packet Switched (PS) domain. A direct tunnel capable SGSN, such as SGSN 160 in FIG. 2B, can be configured on a per GGSN and per RNC basis whether or not the SGSN can use a direct user plane connection. The SGSN 160 in FIG. 2B handles the control plane signaling and makes the decision of when to establish Direct Tunnel. When the Radio Bearer (RAB) assigned for a PDP context is released (i.e. the PDP context is preserved) the GTP-U tunnel is established between the GGSN 165 and SGSN 160 in order to be able to handle the downlink packets.

The optional Direct Tunnel between the SGSN 160 and GGSN 165 is not typically allowed (i) in the roaming case (e.g., because the SGSN needs to know whether the GGSN is in the same or different PLMN), (ii) where the SGSN has received Customized Applications for Mobile Enhanced Logic (CAMEL) Subscription Information in the subscriber profile from a Home Location Register (HLR) and/or (iii) where the GGSN 165 does not support GTP protocol version 1. With respect to the CAMEL restriction, if Direct Tunnel is established then volume reporting from SGSN 160 is not possible as the SGSN 160 no longer has visibility of the User Plane. Thus, since a CAMEL server can invoke volume reporting at anytime during the life time of a PDP Context, the use of Direct Tunnel is prohibited for a subscriber whose profile contains CAMEL Subscription Information.

The SGSN 160 can be operating in a Packet Mobility Management (PMM)-detached state, a PMM-idle state or a PMM-connected state. In an example, the GTP-connections shown in FIG. 2B for Direct Tunnel function can be established whereby the SGSN 160 is in the PMM-connected state and receives an Iu connection establishment request from the UE. The SGSN 160 ensures that the new Iu connection and the existing Iu connection are for the same UE, and if so, the SGSN 160 processes the new request and releases the existing Iu connection and all RABs associated with it. To ensure that the new Iu connection and the existing one are for the same UE, the SGSN 160 may perform security functions. If Direct Tunnel was established for the UE, the SGSN 160 sends an Update PDP Context Request(s) to the associated GGSN(s) 165 to establish the GTP tunnels between the SGSN 160 and GGSN(s) 165 in case the Iu connection establishment request is for signaling only. The SGSN 160 may immediately establish a new direct tunnel and send Update PDP Context Request(s) to the associated GGSN(s) 165 and include the RNC's Address for User Plane, a downlink Tunnel Endpoint Identifier (TEID) for data in case the Iu connection establishment request is for data transfer.

The UE also performs a Routing Area Update (RAU) procedure immediately upon entering PMM-IDLE state when the UE has received a RRC Connection Release message with cause “Directed Signaling connection re-establishment” even if the Routing Area has not changed since the last update. In an example, the RNC will send the RRC Connection Release message with cause “Directed Signaling Connection re-establishment” when it the RNC is unable to contact the Serving RNC to validate the UE due to lack of Iur connection (e.g., see TS 25.331 [52]). The UE performs a subsequent service request procedure after successful completion of the RAU procedure to re-establish the radio access bearer when the UE has pending user data to send.

The PDP context is a data structure present on both the SGSN 160 and the GGSN 165 which contains a particular UE's communication session information when the UE has an active GPRS session. When a UE wishes to initiate a GPRS communication session, the UE must first attach to the SGSN 160 and then activate a PDP context with the GGSN 165. This allocates a PDP context data structure in the SGSN 160 that the subscriber is currently visiting and the GGSN 165 serving the UE's access point.

FIG. 2C illustrates an example of the wireless communications system 100 of FIG. 1 in more detail. In particular, referring to FIG. 2C, UEs 1 . . . N are shown as connecting to the RAN 120 at locations serviced by different packet data network end-points. The illustration of FIG. 2C is specific to W-CDMA systems and terminology, although it will be appreciated how FIG. 2C could be modified to confirm with a 1x EV-DO system. Accordingly, UEs 1 and 3 connect to the RAN 120 at a portion served by a first packet data network end-point 162 (e.g., which may correspond to SGSN, GGSN, PDSN, a home agent (HA), a foreign agent (FA), etc.). The first packet data network end-point 162 in turn connects, via the routing unit 188, to the Internet 175 and/or to one or more of an authentication, authorization and accounting (AAA) server 182, a provisioning server 184, an Internet Protocol (IP) Multimedia Subsystem (IMS)/Session Initiation Protocol (SIP) Registration Server 186 and/or the application server 170. UEs 2 and 5 . . . N connect to the RAN 120 at a portion served by a second packet data network end-point 164 (e.g., which may correspond to SGSN, GGSN, PDSN, FA, HA, etc.). Similar to the first packet data network end-point 162, the second packet data network end-point 164 in turn connects, via the routing unit 188, to the Internet 175 and/or to one or more of the AAA server 182, a provisioning server 184, an IMS/SIP Registration Server 186 and/or the application server 170. UE 4 connects directly to the Internet 175, and through the Internet 175 can then connect to any of the system components described above.

Referring to FIG. 2C, UEs 1, 3 and 5 . . . N are illustrated as wireless cell-phones, UE 2 is illustrated as a wireless tablet-PC and UE 4 is illustrated as a wired desktop station. However, in other embodiments, it will be appreciated that the wireless communication system 100 can connect to any type of UE, and the examples illustrated in FIG. 2C are not intended to limit the types of UEs that may be implemented within the system. Also, while the AAA 182, the provisioning server 184, the IMS/SIP registration server 186 and the application server 170 are each illustrated as structurally separate servers, one or more of these servers may be consolidated in at least one embodiment of the invention.

Further, referring to FIG. 2C, the application server 170 is illustrated as including a plurality of media control complexes (MCCs) 1 . . . N 170B, and a plurality of regional dispatchers 1 . . . N 170A. Collectively, the regional dispatchers 170A and MCCs 170B are included within the application server 170, which in at least one embodiment can correspond to a distributed network of servers that collectively functions to arbitrate communication sessions (e.g., half-duplex group communication sessions via IP unicasting and/or IP multicasting protocols) within the wireless communication system 100. For example, because the communication sessions arbitrated by the application server 170 can theoretically take place between UEs located anywhere within the system 100, multiple regional dispatchers 170A and MCCs are distributed to reduce latency for the arbitrated communication sessions (e.g., so that a MCC in North America is not relaying media back-and-forth between session participants located in China). Thus, when reference is made to the application server 170, it will be appreciated that the associated functionality can be enforced by one or more of the regional dispatchers 170A and/or one or more of the MCCs 170B. The regional dispatchers 170A are generally responsible for any functionality related to establishing a communication session (e.g., handling signaling messages between the UEs, scheduling and/or sending announce messages, etc.), whereas the MCCs 170B are responsible for hosting the communication session for the duration of the call instance, including conducting an in-call signaling and an actual exchange of media during an arbitrated communication session.

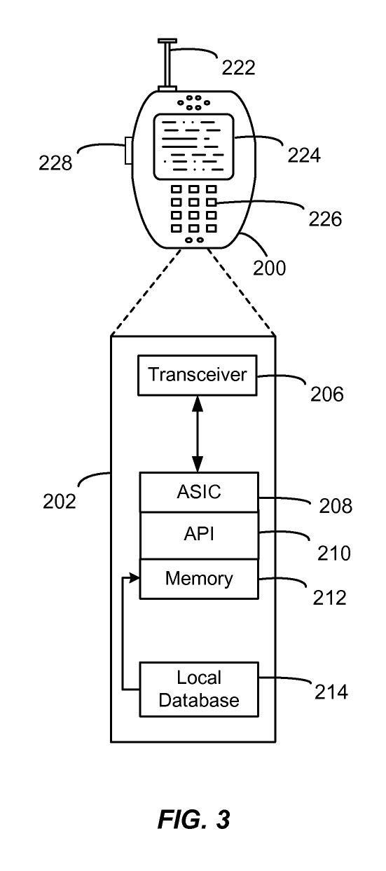

Referring to FIG. 3, a UE 200, (here a wireless device), such as a cellular telephone, has a platform 202 that can receive and execute software applications, data and/or commands transmitted from the RAN 120 that may ultimately come from the core network 126, the Internet and/or other remote servers and networks. The platform 202 can include a transceiver 206 operably coupled to an application specific integrated circuit (“ASIC” 208), or other processor, microprocessor, logic circuit, or other data processing device. The ASIC 208 or other processor executes the application programming interface (“API’) 210 layer that interfaces with any resident programs in the memory 212 of the wireless device. The memory 212 can be comprised of read-only or random-access memory (RAM and ROM), EEPROM, flash cards, or any memory common to computer platforms. The platform 202 also can include a local database 214 that can hold applications not actively used in memory 212. The local database 214 is typically a flash memory cell, but can be any secondary storage device as known in the art, such as magnetic media, EEPROM, optical media, tape, soft or hard disk, or the like. The internal platform 202 components can also be operably coupled to external devices such as antenna 222, display 224, push-to-talk button 228 and keypad 226 among other components, as is known in the art.

Accordingly, an embodiment of the invention can include a UE including the ability to perform the functions described herein. As will be appreciated by those skilled in the art, the various logic elements can be embodied in discrete elements, software modules executed on a processor or any combination of software and hardware to achieve the functionality disclosed herein. For example, ASIC 208, memory 212, API 210 and local database 214 may all be used cooperatively to load, store and execute the various functions disclosed herein and thus the logic to perform these functions may be distributed over various elements. Alternatively, the functionality could be incorporated into one discrete component. Therefore, the features of the UE 200 in FIG. 3 are to be considered merely illustrative and the invention is not limited to the illustrated features or arrangement.

The wireless communication between the UE 102 or 200 and the RAN 120 can be based on different technologies, such as code division multiple access (CDMA), W-CDMA, time division multiple access (TDMA), frequency division multiple access (FDMA), Orthogonal Frequency Division Multiplexing (OFDM), the Global System for Mobile Communications (GSM), or other protocols that may be used in a wireless communications network or a data communications network. For example, in W-CDMA, the data communication is typically between the client device 102, Node B(s) 124, and the RNC 122. The RNC 122 can be connected to multiple data networks such as the core network 126, PSTN, the Internet, a virtual private network, a SGSN, a GGSN and the like, thus allowing the UE 102 or 200 access to a broader communication network. As discussed in the foregoing and known in the art, voice transmission and/or data can be transmitted to the UEs from the RAN using a variety of networks and configurations. Accordingly, the illustrations provided herein are not intended to limit the embodiments of the invention and are merely to aid in the description of aspects of embodiments of the invention.

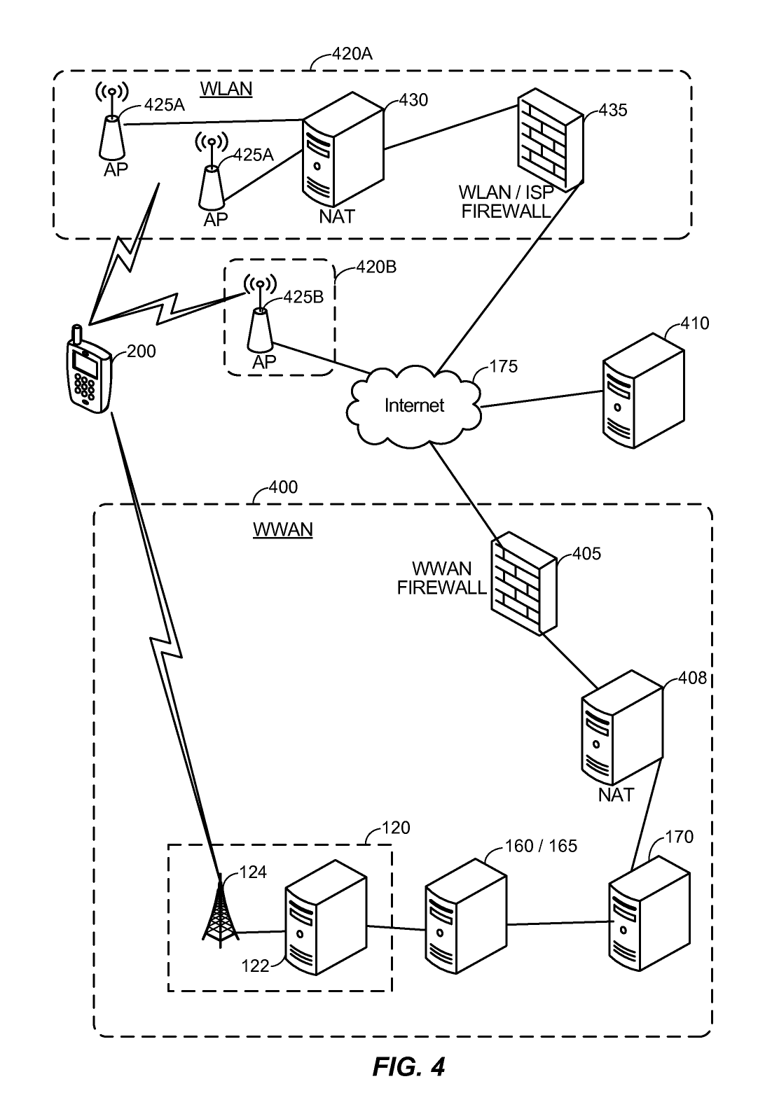

FIG. 4 illustrates the wireless communication system of FIG. 1 in accordance with another embodiment of the invention. As shown in FIG. 4, UE 200 is configured to connect concurrently to a Wireless Wide Area Network (WWAN) 400 via a Node B 124 within the RAN 120 and a Wireless Local Area Network (WLAN) 420A or 420B via a WLAN Access Point (AP) 425A or 425B (e.g., a WiFi hotspot or router). The network components of the WWAN 400, which may correspond to a service provider network, include the RAN 120, the SGSN 160, the GGSN 165 and the application server 170, as discussed above with respect to FIGS. 1, 2A, 2B and 2C. In FIG. 4, the WWAN 400 further includes a WWAN firewall 405, which may also be referred to as a service provider firewall, and a Network Address Translation (NAT) component 408. While the NAT 408 and WWAN firewall 405 are illustrated as separate entities or components in FIG. 4, it will be appreciated that their respective functions can be consolidated into a single server or switch in other embodiments of the invention (e.g., such as routing unit 188 of FIG. 2C, for example). The functionality of the NAT 408 is described in more detail below with respect to NAT 430 that is positioned within the WLAN 420A.

As will be appreciated by one of ordinary skill in the art, firewalls can be implemented in hardware, software or a combination of both. Firewalls are frequently used to prevent unauthorized Internet users from accessing private networks, in this case the service provider network or WWAN 400, that are connected to the Internet 175. The WWAN firewall 405 is configured to permit or deny network transmissions based upon a set of rules and other criteria. All messages entering or leaving the WWAN 400 via the Internet 175 pass through the WWAN firewall 405, which inspects each message and blocks those that do not meet the specified security criteria.

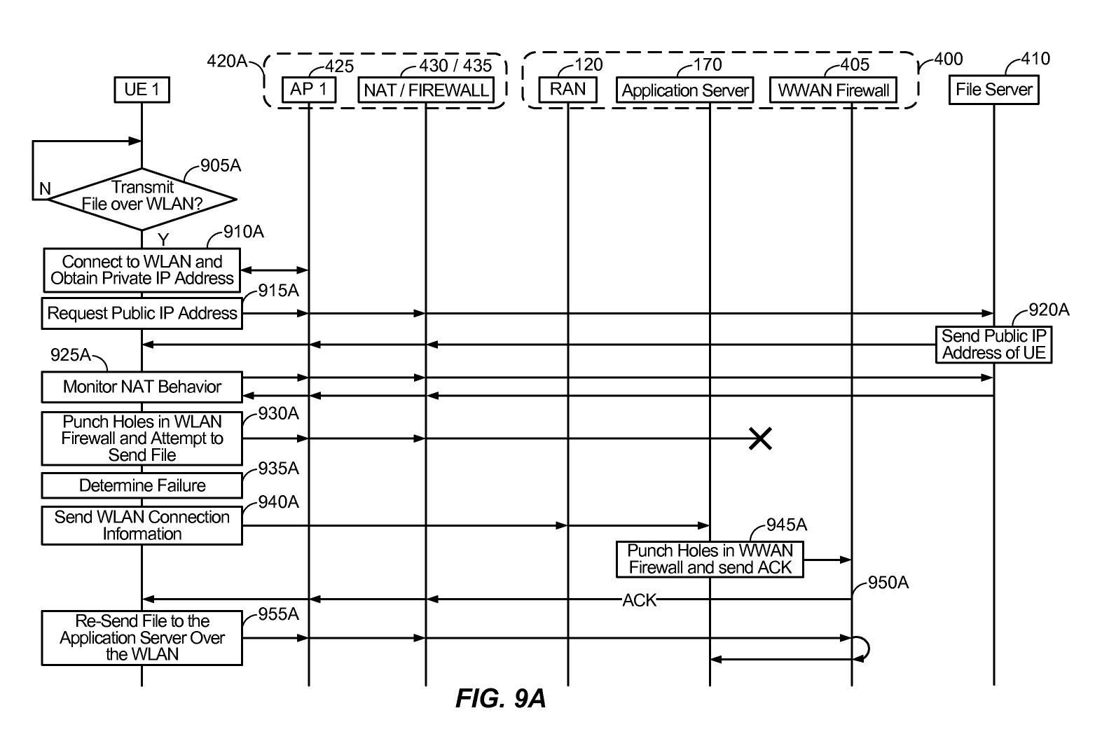

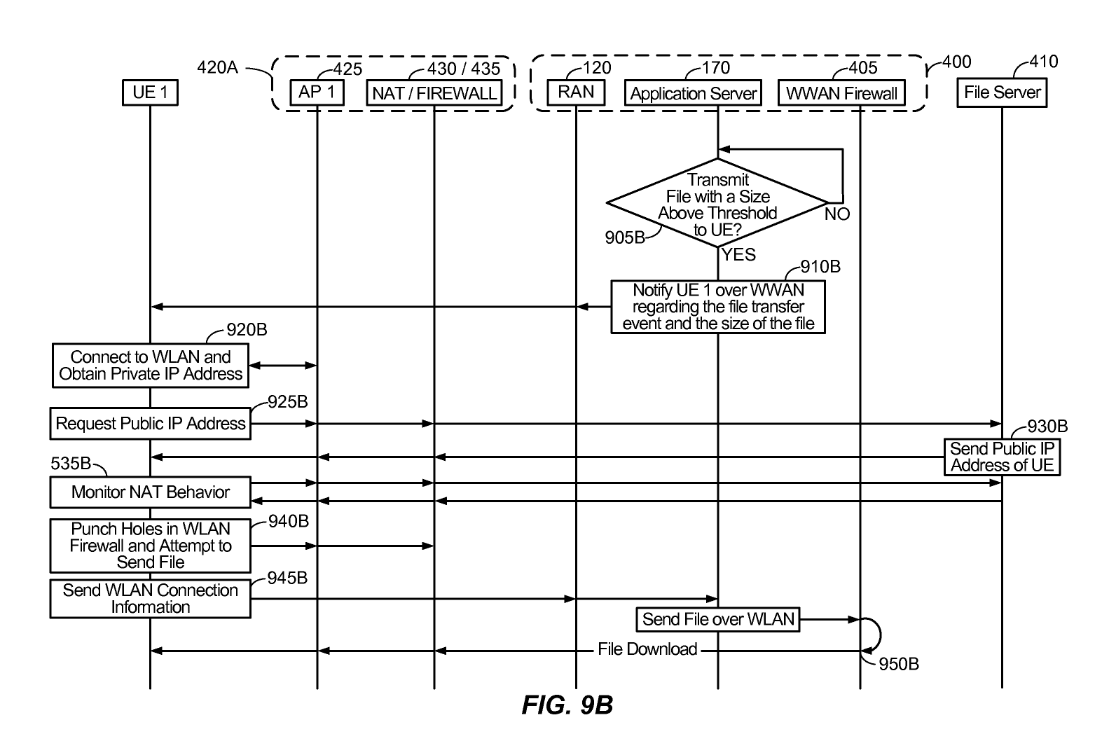

By punching through the WWAN firewall 405, the application server 170 can access the Internet 175. As shown in FIG. 4, the Internet 175 is connected to both WLANs 420A and 420B and to a file server 410, which is positioned outside of both the WWAN firewall 405 and a WLAN firewall 435 (discussed below in more detail with respect to FIGS. 9A and 9B). Through the Internet 175, the application server 170 of the WWAN 400 is theoretically connected to the WLAN 420A, although it will be appreciated that the WLAN 420A has its own security (e.g., a NAT/Firewall) that may block access.

Turning to the WLAN 420A, the WLAN 420A includes the WLAN AP(s) 425A (e.g., a WiFi router or hotspot, etc.) that was mentioned above, and further includes a Network Address Translation (NAT) 430 and a WLAN firewall 435, which may alternatively be referred to as an Internet Service Provider (ISP) firewall. While the NAT 430 and WLAN firewall 435 are illustrated as separate entities or components in FIG. 4, it will be appreciated that their respective functions can be consolidated into a single server or switch in other embodiments of the invention (e.g., such as routing unit 188 of FIG. 2B, for example).

In FIG. 4, the separate WLANs 420A and 420B demonstrate that not all WLAN hotspots or APs 425A or 425B are necessarily behind the same NAT and/or firewall, even if the WLAN hotspots are relatively close to each other geographically. While not shown explicitly in FIG. 4, the WLAN 420B can further include its own NAT (e.g., similar to NAT 430 in WLAN 420A) and firewall (e.g., similar to WLAN firewall 435 in WLAN 420A or an ISP associated with the WLAN 420A).

Referring to FIG. 4, NAT 430 and WLAN firewall 435 separate the WLAN 420A from the Internet 175 and/or other core networks or WLANs. For example, the NAT 430 can be configured to modify network address information in datagram (IP) packet headers such that outgoing Internet Protocol (IP) packets from the WLAN 420A appear to originate from the NAT 430 instead of the originator of the IP-packet (e.g., UE 200), and incoming IP packets appear to terminate at the NAT 430. The NAT 430 can be implemented in accordance with any of a variety of schemes of translating addresses and/or port numbers, with each type of NAT-scheme affecting application communication protocols differently. For example, NAT-types include full-cone NAT (also known as one-to-one NAT), address-restricted cone NAT, port-restricted cone NAT and symmetric NAT.

With respect to the WLAN firewall 435, the WLAN firewall 435 can be implemented in hardware, software or a combination of both. Firewalls are frequently used to prevent unauthorized Internet users from accessing private networks, such as intranets, that are connected to the Internet 175. The WLAN firewall 435 is configured to permit or deny network transmissions based upon a set of rules and other criteria. All messages entering or leaving the WLAN 420A pass through the WLAN firewall 435, which inspects each message and blocks those that do not meet the specified security criteria. Further, the WLAN firewall 435 provides private addresses as defined in RFC 1918 to the hosts protected behind the WLAN firewall 435. Once a pass through connection is opened through the WLAN firewall 435, NAT translation association for the data session is often released by the NAT 430 within a few seconds of data inactivity for the session. Thus, the NAT 430 and WLAN Firewall 435 are used to collectively refer to the hardware and/or software that performs the firewall and NAT functions for a particular intranet, in this case the WLAN 420A.

UEs can typically obtain higher bandwidth via the WLAN 420A or 420B (e.g., WiFi hotspots, etc.) as compared to the WWAN 400 (e.g., a cellular communications system, etc.). Accordingly, precious WWAN bandwidth may be consumed if the WWAN is used for large file transfers (uploads or downloads) when the WLAN could be used instead, or when the UE could have waited for a WLAN connection before initiating the large file transfer. However, it can be difficult to send data from UE 200 to the application server 170 within the WWAN 400 over the WLAN 420A or 420B due to the security settings of the NAT 430, WLAN firewall 435 and the WWAN firewall 405.

Conventionally, a UE will attempt to switch from a WWAN connection to a WLAN connection to transmit media when a WLAN is available. Data transfer conducted over the WLAN 420A or 420B is generally cheaper and can also be faster as compared to the WWAN 400.

The UE will typically select between different WLAN APs based on a signal strength of a beacon signal or pilot signal from the WLAN AP. However, some WLANs are congested and have poor backhaul performance. Also, the NAT and/or firewall present in some WLANs can block certain services such as push applications. Thus, a strong WLAN AP pilot signal does not guarantee good WLAN performance. Further, most WiFi radios on UEs are “always-on”, such that the UE is continuously searching for new WLANs. While this permits quick detection of WLANs that enter range of the UE, battery life on the UE is degraded.

Accordingly, embodiments of the invention are directed to providing WLAN AP selection assistance information based on local environment information associated with a given UE. Once the given UE connects to an AP based on the WLAN AP selection assistance information, an estimated duration that the given UE is expected to be connected to the AP is calculated. The given UE's connection to the AP is then advertised based on the estimated duration. For example, an estimated file size that can be exchanged by the given UE can be calculated based on the estimated duration and then advertised to the application server 170 and/or one or more other UEs to facilitate a decision related to whether to initiate a large file transfer with the given UE. Further, the WLAN AP selection assistance information can be received from an external entity (e.g., application server 170), such that the WLAN radio on the given UE can remain off except when attempting to locate WLANs based on the WLAN AP selection assistance information.

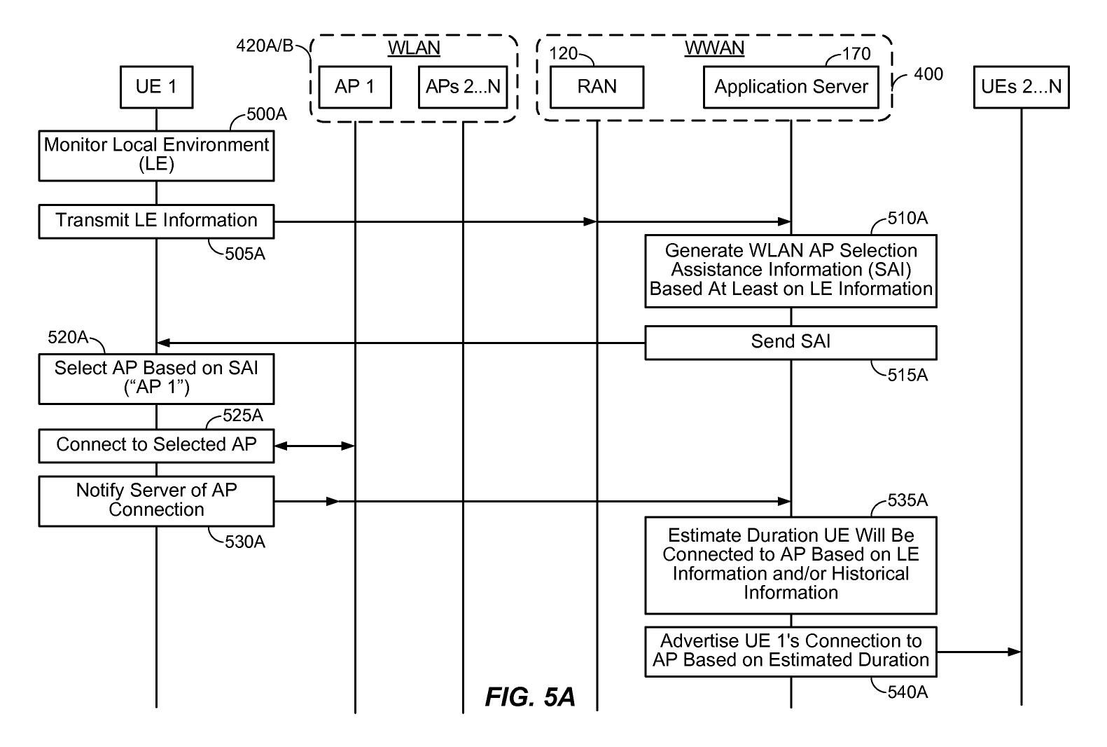

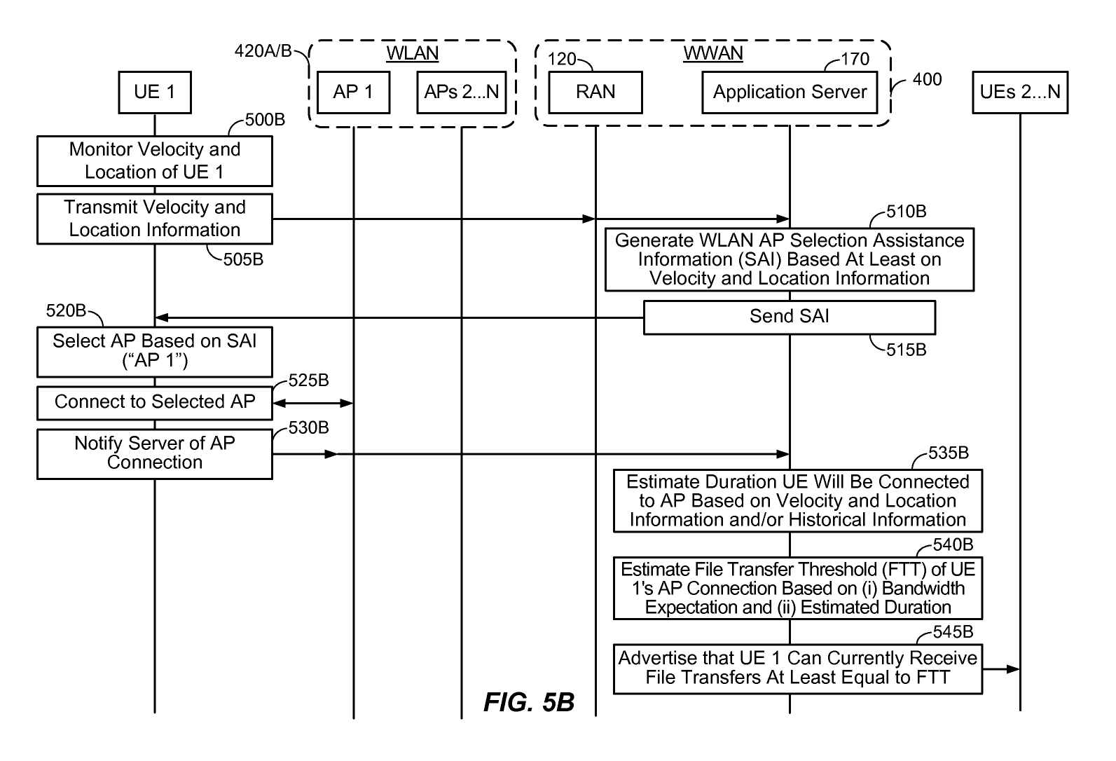

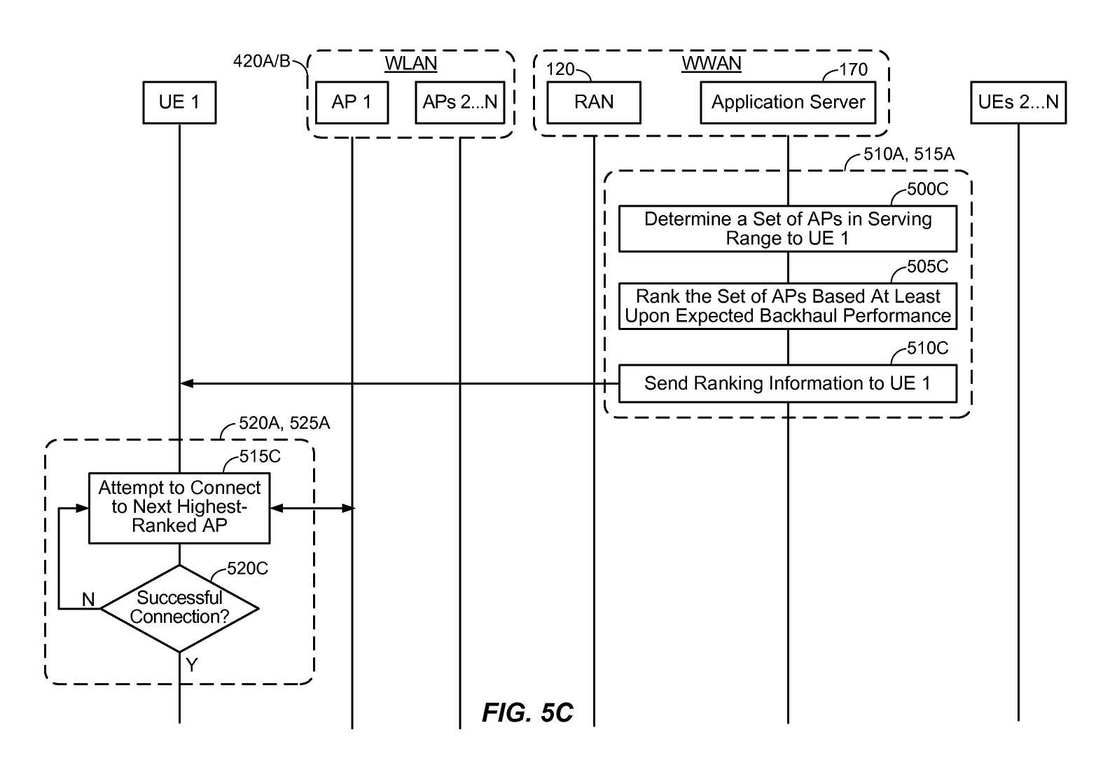

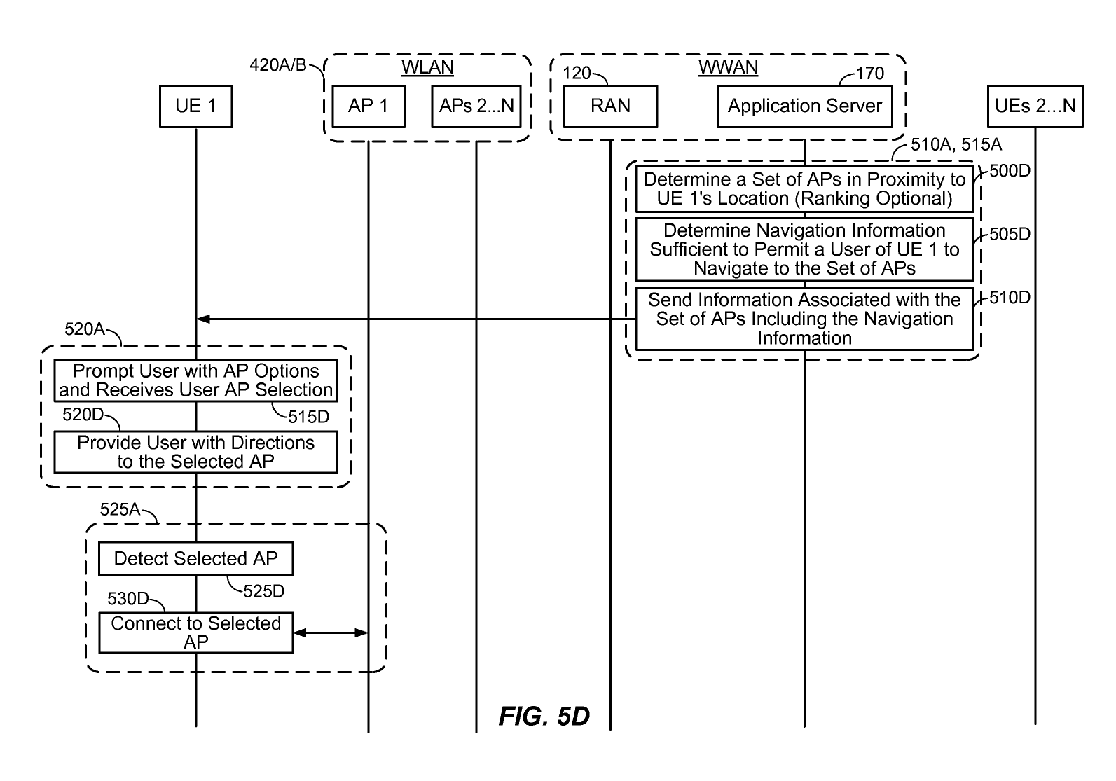

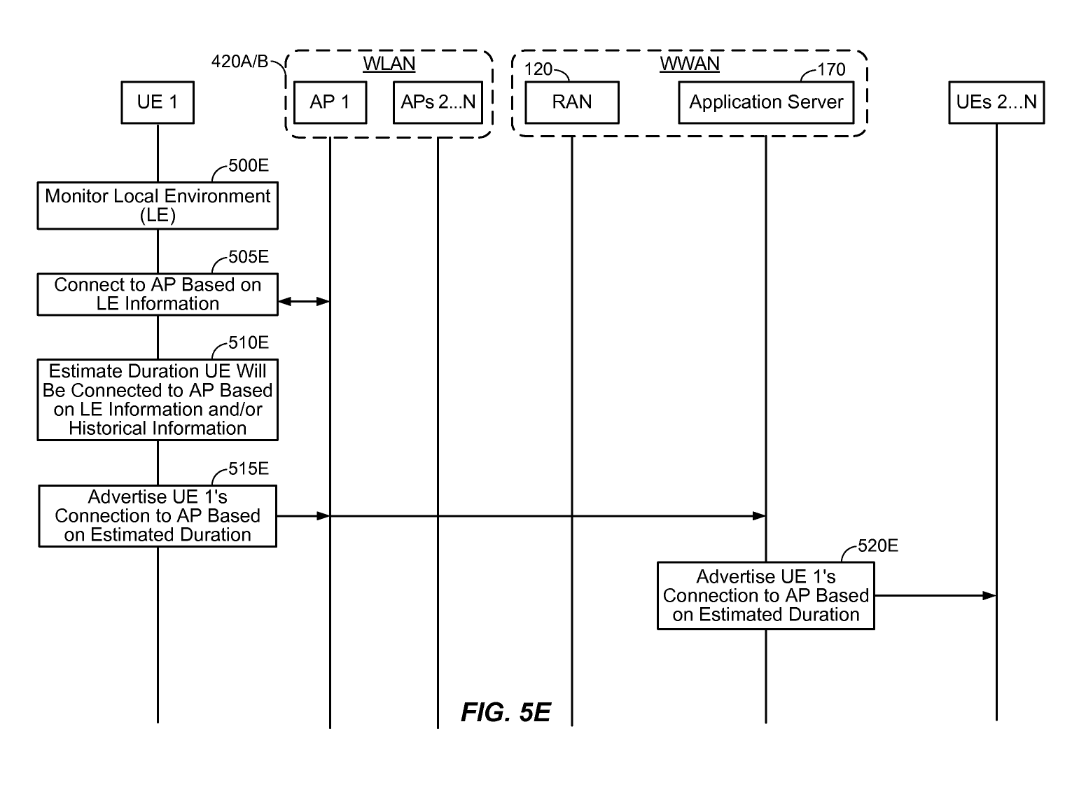

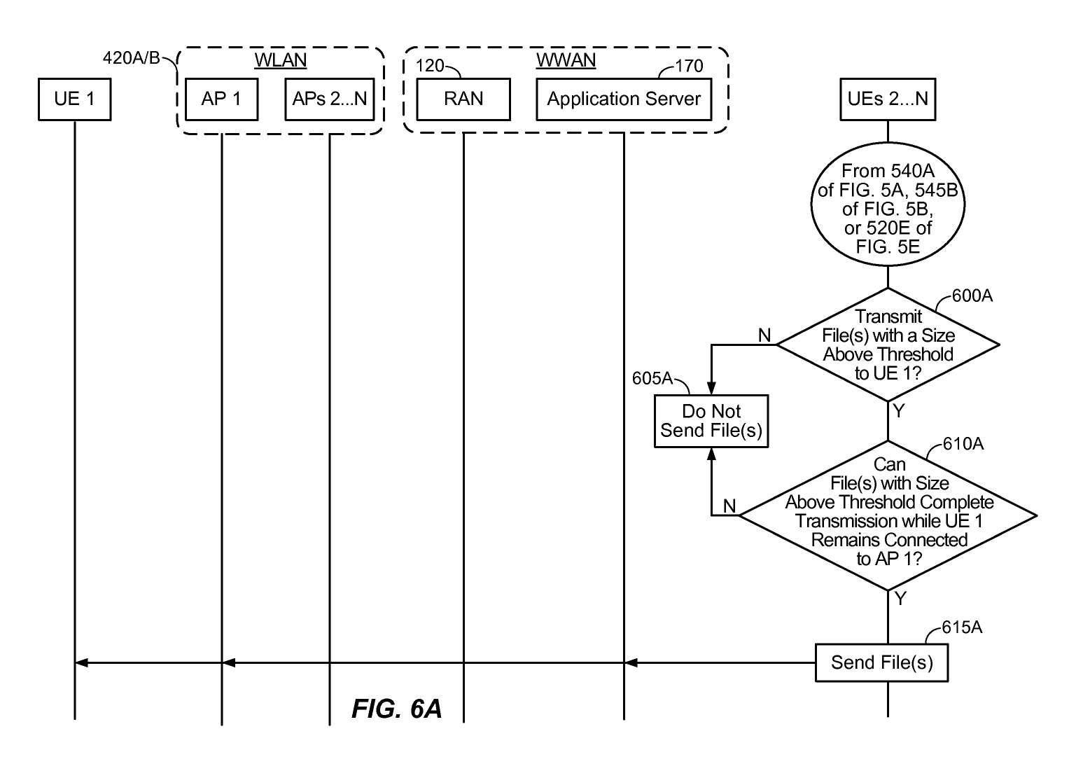

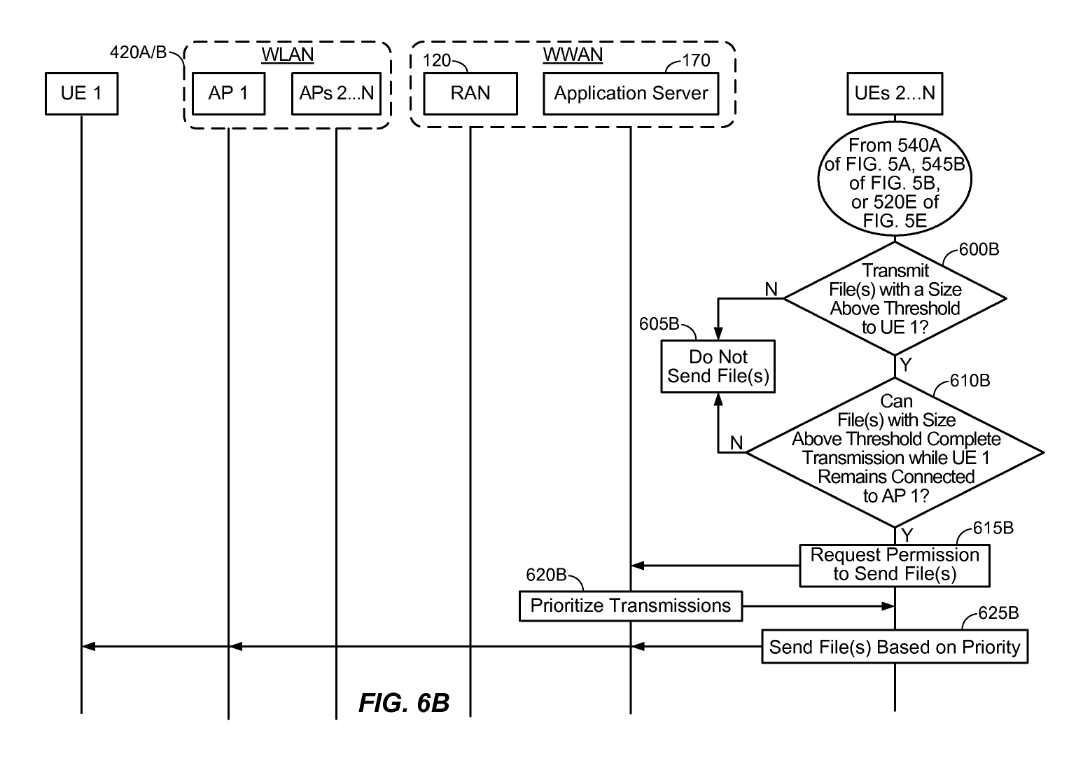

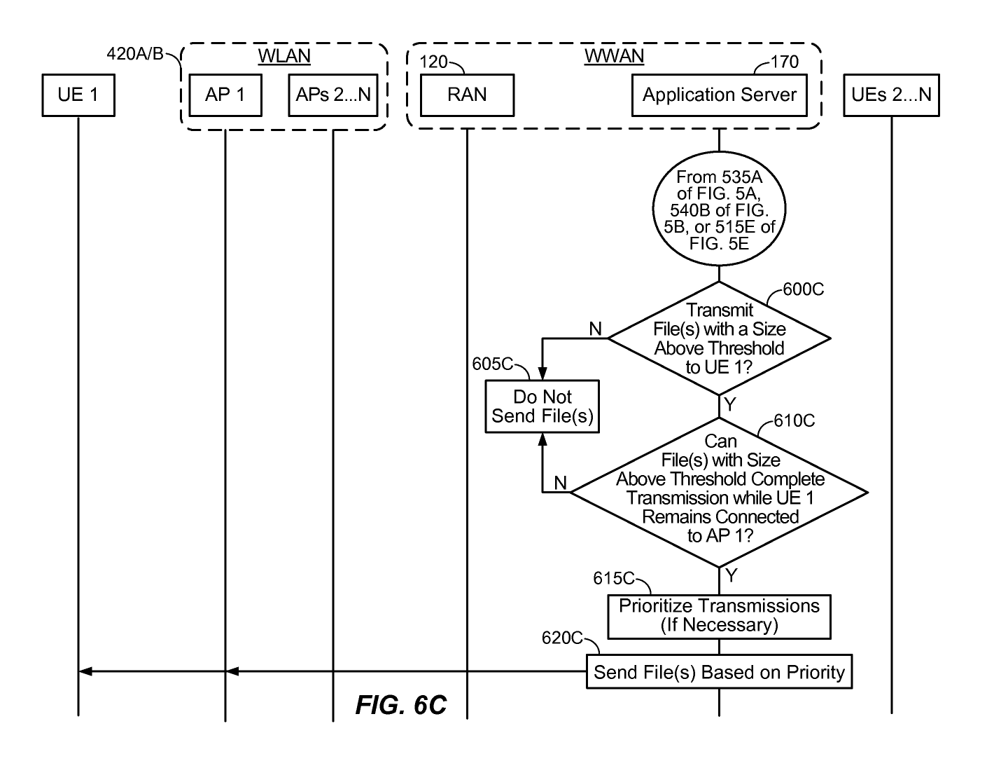

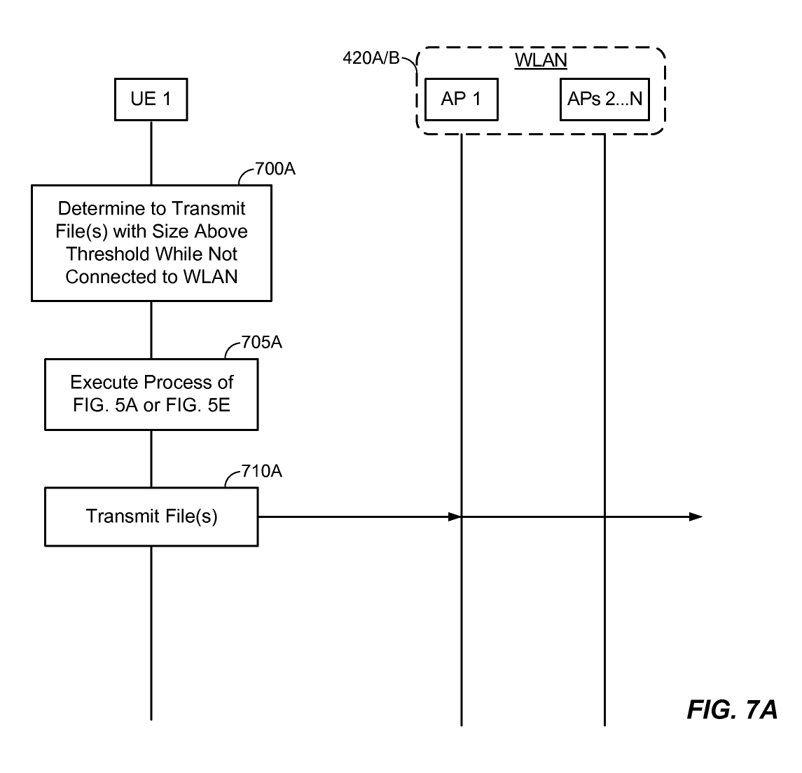

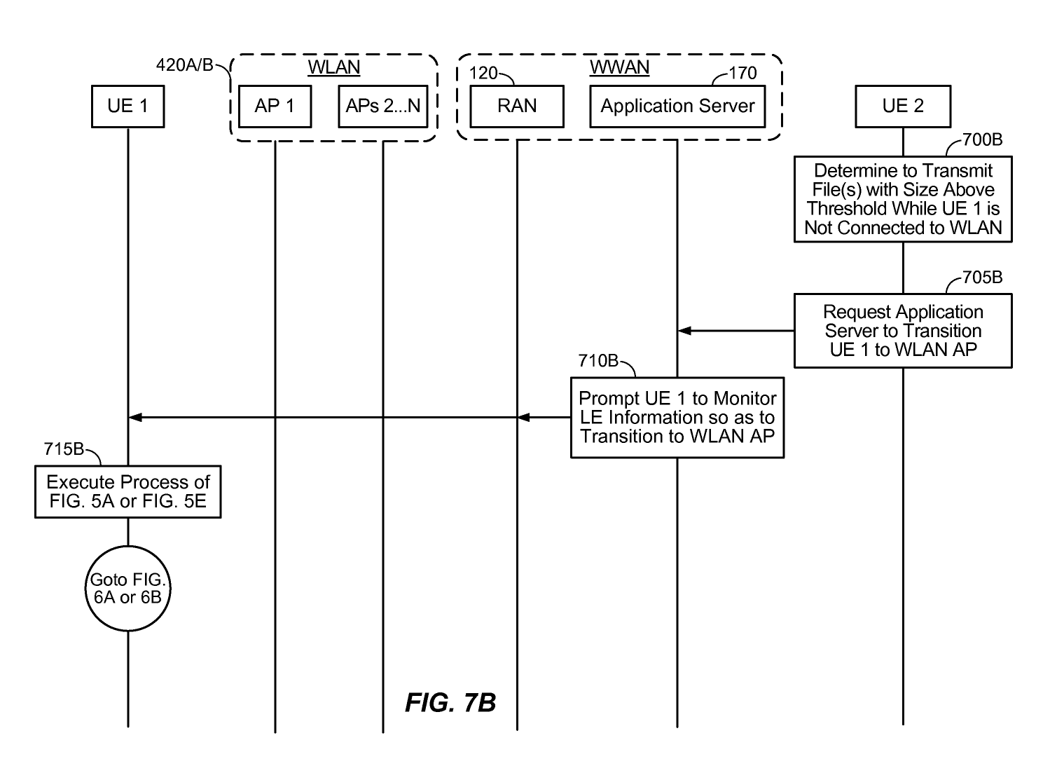

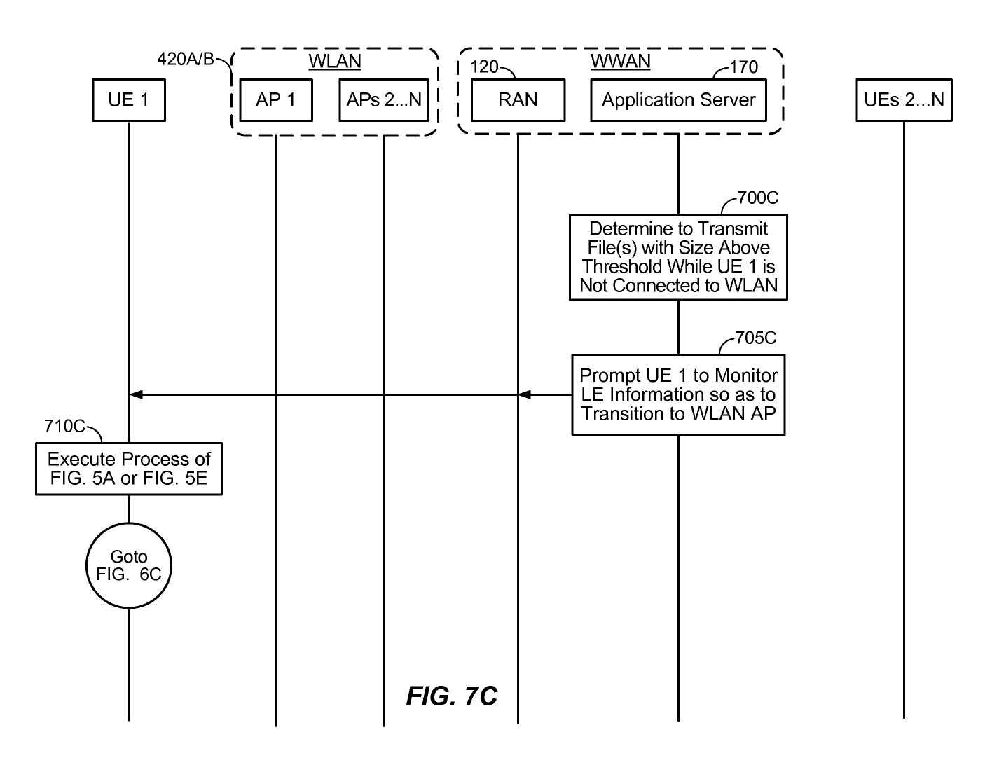

FIG. 5A illustrates a process of establishing a connection to a given WLAN AP based on WLAN AP selection assistance information and then advertising the connection in accordance with an embodiment of the invention. In particular, FIG. 5A relates to an embodiment whereby an estimated duration of a given UE's (“UE 1”) connection to the WLAN AP is calculated at the application server 170.

Referring to FIG. 5A, UE 1 monitors local environment information in 500A. The monitoring that occurs in 500A can include (i) monitoring a geographic location of UE 1 (e.g., based on GPS, etc.), (ii) monitoring a speed of UE 1 (e.g., via an accelerometer, etc.), (iii) monitoring local beacon signals from local fixed stations (e.g., WWAN base stations, WLAN APs, etc.), (iv) UE 1's directional velocity (towards the access point, away from the access point) and/or (v) any combination thereof. Generally, the local environment information monitored at 500A can include any information sufficient for the application server 170 to infer a location of the UE 1 so that WLAN AP(s) in proximity to UE 1 can be identified and then selectively recommended to UE 1. While not shown explicitly in FIG. 5A, the monitoring of the local environment information that occurs at 500A to permit the application server 170 to generate the WLAN AP selection assistance information can be triggered responsive to (i) a mobile-originated large file transfer (e.g., discussed in more detail below with respect to FIG. 7A), (ii) a mobile-terminated large file transfer that originates from another UE (e.g., discussed in more detail below with respect to FIG. 7B), or (iii) a server-originated large file transfer (e.g., discussed in more detail below with respect to FIG. 7C).

After monitoring the local environment information in 500A, UE 1 transmits the local environment information to the application server 170 over the WWAN 400, 505A. In 505A, UE 1 may either set-up a connection to the WWAN 400 to accommodate the transmission, or alternatively UE 1 may leverage a pre-existing connection to the WWAN 400 to accommodate the transmission.

Referring to FIG. 5A, the application server 170 receives the local environment information from UE 1 over the WWAN 400 and uses the local environment information to generate WLAN AP selection assistance information, 510A. For example, the application server 170 may track a performance history associated with one or more WLANs and/or WLAN APs. The application server 170 can then use the local environment information to determine which WLAN APs are proximate to UE 1. The application server 170 can then predict a current performance level of the proximate WLAN APs based in part on the performance histories and/or the local environment information. The predicted current performance levels can be used to rank the proximate WLAN APs so that UE 1 need not rely solely upon the pilot strengths of its local WLAN APs. In another example, the application server 170 can infer that UE 1 is moving on local streets towards a high bandwidth femto cell and an imminent stop (traffic light) would be an ideal opportunity to schedule the file transfer. In this case, the application server 170 provides the femto AP the highest rank to facilitate the fast file transfer so that UE 1 can switch to the femto AP once in range. Other examples of how the local environment information can be used to generate the WLAN AP selection assistance information will be described in more detail below.

After generating the WLAN AP selection assistance information in 510A, the application server 170 transmits the WLAN AP selection assistance information to UE 1 over the WWAN 400, 515A. UE 1 receives the WLAN AP selection assistance information and then uses the WLAN AP selection assistance information to select an AP (“AP 1”), 520A. At some later point in time, UE 1 connects to the selected WLAN AP, 525A. For example, the selected WLAN AP may be out-of-range of a current position of UE 1, such that the selection at 520A results in navigation information being presented by UE 1 to a user so that the user can move closer to the selected WLAN AP. The connection that occurs at 525A may thereby occur after the user has successfully navigated to a range of the selected WLAN AP.

After connecting to the selected WLAN AP (“AP 1”, which is described below as part of WLAN 420A) in 525A, UE 1 notifies the application server 170 of its connection status, 530A. As an example, UE 1 may punch holes through the WLAN firewall 435 and/or WLAN NAT 430 of the WLAN 420A in order to transmit the notification of 530A, as will be described below in greater detail with respect to FIGS. 9A and 9B.

Once the application server 170 is notified of UE 1's connection to AP 1, the application server 170 estimates a duration that UE 1 is expected to remain connected to AP 1 based on (i) the local environment information from 505A and/or (ii) historical information, 535A. For example, if the local environment information indicates that UE 1 is being driven at 20 MPH past a WLAN AP and then stops at a red light, the estimated duration may correspond to a projected time to a transition to a green light plus an estimate of when the UE 1's projected speed (e.g., 20 MPH) will move UE 1 out of range of the WLAN AP. Other examples of estimating the duration of UE 1's connection to a given WLAN AP will be discussed below in more detail.

Referring to FIG. 5A, after calculating the estimated duration in 535A, the application server 170 then advertises UE 1's connection to AP 1 based on the estimated duration to one or more UEs 2 . . . N, 540A. For example, UEs 2 . . . N may correspond to UEs that have registered with the application server 170 and have indicated a desire either to receive notifications of when UE 1 is WLAN-connected or have indicated a desire to initiate a large file transfer with UE 1. Examples of how UEs 2 . . . N may respond to UE 1's connection advertisement are discussed below in more detail with respect to FIGS. 6A and 6B.

FIG. 5B illustrates a more detailed implementation example of the process of FIG. 5A in accordance with an embodiment of the invention. In particular, the local environment information monitored by UE 1 in FIG. 5B corresponds to a velocity (i.e., speed and direction) and location of UE 1, and UE 1's AP-connection is advertised along with an indication of a file size that UE 1 is expected to be capable of receiving while connected to the AP (e.g., based on the estimated connectivity duration and a bandwidth prediction over the AP). As used herein, the term “size” or “file size” can be used to refer to a data file length (e.g., 2 megabytes, 1.5 gigabytes, 180 kilobytes, etc.), or alternatively can be based on data rate and/or time for streaming-type data.

Referring to FIG. 5B, UE 1 monitors a velocity and location of UE 1, 500B. For example, UE 1 can monitor its speed using an accelerometer and/or GPS, and can then derive its velocity (i.e., speed plus direction) based on how its location is moving at the monitored speed. Further, UE 1 can monitor its location using a geographic positioning procedure (e.g., GPS, hybrid cellular/GPS, etc.), or alternatively based on secondary factors (e.g., monitoring local beacon signals from local fixed stations such as WWAN base stations, WLAN APs, etc.). As will be appreciated, 500B corresponds to an implementation example of 500A of FIG. 5A.

Referring to FIG. 5B, after monitoring the velocity and location of UE 1 in 500B, UE 1 transmits the velocity and location information of UE 1 to the application server 170 over the WWAN 400, 505B (e.g., as in 505A). In 505B, UE 1 may either set-up a connection to the WWAN 400 to accommodate the transmission, or alternatively UE 1 may leverage a pre-existing connection to the WWAN 400 to accommodate the transmission.

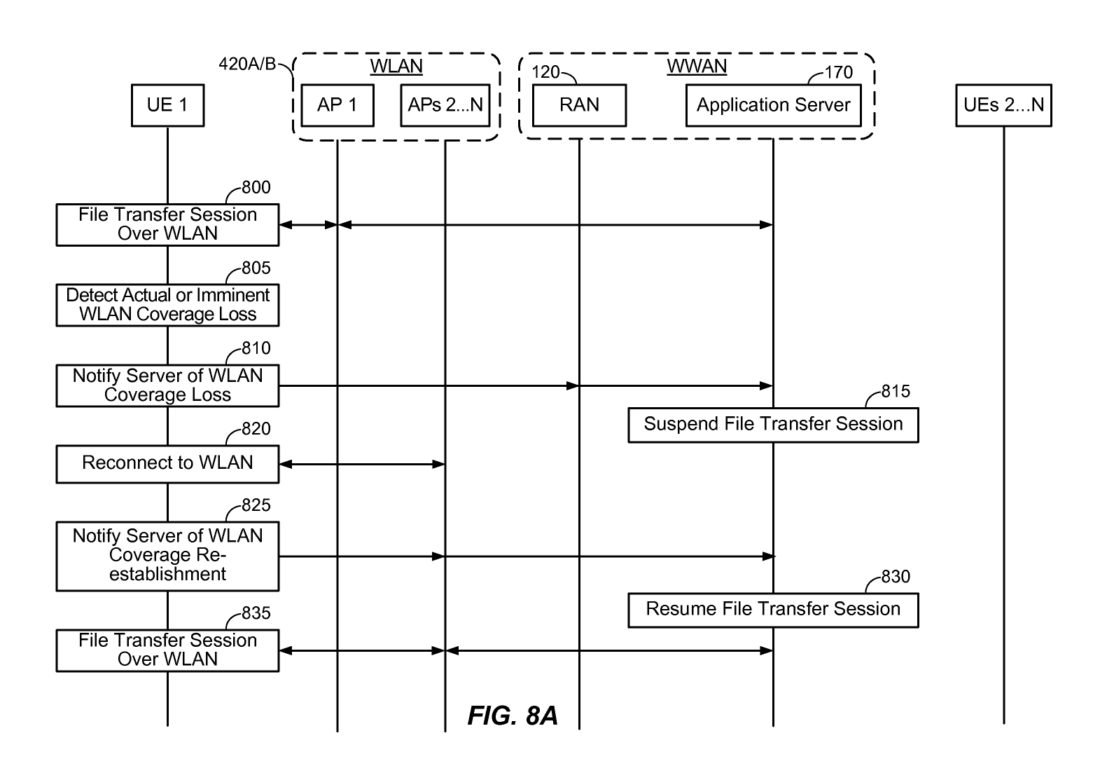

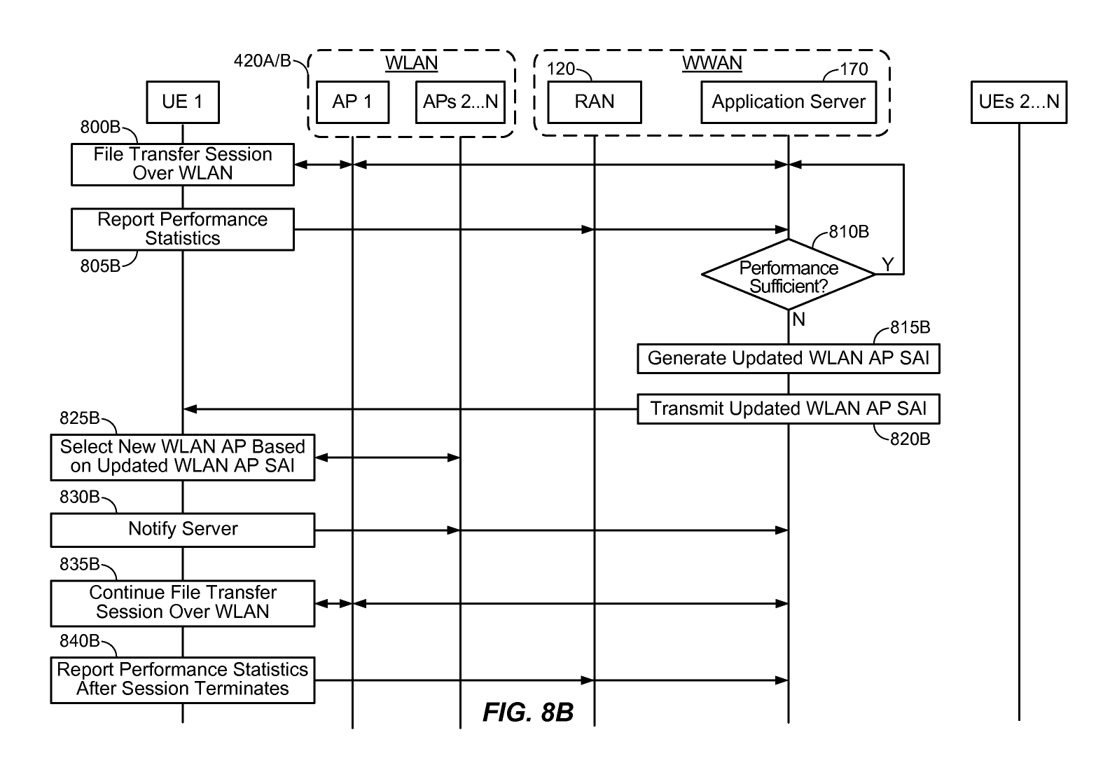

Referring to FIG. 5B, the application server 170 receives the velocity and location information from UE 1 over the WWAN 400 and uses the velocity and location information to generate WLAN AP selection assistance information, 510B. For example, the application server 170 may use the location of UE 1 to populate a list of proximate WLAN APs, such as WLAN APs within a mile of UE 1. The list of proximity WLAN APs may then be filtered to as to exclude WLAN APs from the list of WLAN APs that are not in a direction that UE 1 is moving towards based on UE 1's current velocity. Also, if UE 1 is moving fairly fast, WLAN APs that will soon be out-of-range of UE 1 may also be excluded from the list of WLAN APs. Next, from the WLAN APs that are not excluded from the list, the application server may load performance history information associated with the WLAN APs (e.g., based on previously reporting performance statistics, discussed in more detail below with respect to FIG. 8B). The application server 170 can use the performance history information to predict a performance of the WLAN APs for UE 1. The application server 170 can then exclude WLAN APs with a low predicted performance. Finally, any remaining WLAN APs that are not excluded based on their location, the velocity of UE 1 and/or a performance prediction are ranked by the application server 170 (e.g., based on how close they are to UE 1 now or how close they are expected to be to UE 1 in a threshold period of time based on UE 1's velocity, based on the performance prediction, etc.). The application server 170 can then generate the WLAN AP selection assistance information to include a ranked listing of the remaining WLAN APs, and can further configure the WLAN AP selection assistance information to include navigation information associated with the WLAN APs so that, if necessary, UE 1 can prompt its user to navigate towards a selected WLAN AP (e.g., a geographic location or address of the selected WLAN AP, turn-by-turn directions to the selected WLAN AP, etc.). As will be appreciated, 510B corresponds to an implementation example of 510A of FIG. 5A.

After generating the WLAN AP selection assistance information in 510B, the application server 170 transmits the WLAN AP selection assistance information to UE 1 over the WWAN 400, 515B (e.g., as in 515A). UE 1 receives the WLAN AP selection assistance information and then uses the WLAN AP selection assistance information to select an AP (“AP 1”), 520B (e.g., as in 520A). At some later point in time, UE 1 connects to the selected WLAN AP, 525B (e.g., as in 525A).

After connecting to the selected WLAN AP (“AP 1”, which is described below as part of WLAN 420A) in 525B, UE 1 notifies the application server 170 of its connection status, 530B (e.g., as in 530A). Once the application server 170 is notified of UE 1's connection to AP 1, the application server 170 estimates a duration that UE 1 is expected to remain connected to AP 1 based on (i) the velocity and/or speed information from 505B and/or (ii) historical information, 535B (e.g., similar to 535A). For example, when UE 1 selects an AP and is stationary (e.g., an AP at a coffee shop that has historically been selected by UE 1 and at which the user of UE 1 remains for a long period of time), the application server 170 estimates that UE 1 will use this AP for a long duration of time, whereas when UE 1 selects an AP while being on the move (i.e., a non-stationary or dynamic AP), the application server 170 estimates that UE 1 may not necessarily be connected to the AP for a long duration.

Referring to FIG. 5B, after calculating the estimated duration in 535B, the application server 170 further estimates a file transfer threshold associated with UE 1's connection to AP 1, 540B. For example, the application server 170 may load performance history information associated with AP 1 (e.g., which can be based on previously reported performance statistics of UE 1 and/or other UEs over AP 1, discussed in more detail below with respect to FIG. 8B) to predict a bandwidth that UE 1 will be able to achieve over AP 1. The application server 170 can then determine an amount of data that UE 1 can reasonably be expected to transmit and/or receive over AP 1 for the estimated duration of its connection to AP 1. The file transfer threshold can then be set based on the determined amount of data. For example, the file transfer threshold may either be set equal to the determined amount of data or may alternatively be offset somewhat lower than the determined amount of data to increase the probability that a file transfer session exchanging file(s) at or below the file transfer threshold will complete before UE 1 disconnects from AP 1.

After calculating the file transfer threshold in 540B, the application server 170 advertises UE 1's connection to AP 1 to UEs 2 . . . N by indicating that UE 1 can currently receive file transfers at least equal to the file transfer threshold, 545B. Examples of how UEs 2 . . . N may respond to UE 1's connection advertisement are discussed below in more detail with respect to FIGS. 6A and 6B.

FIG. 5C illustrates an example implementation of 510A through 525A of FIG. 5A in accordance with an embodiment of the invention. Referring to FIG. 5C, assume that the local environment information includes a listing of beacon signals that are currently visible by UE 1. Accordingly, the application server 170 determines a set of WLAN APs in serving range of UE 1 based on the local environment information, 500C. For example, in 500C, the application server 170 can look-up the set of WLAN APs based on SSIDs reported by UE 1 that were received at UE 1 within pilot signals or beacon signals from the visible WLAN APs. The application server 170 then ranks the set of WLAN APs based at least upon a predicted level of backhaul performance (e.g., bandwidth, RTT delay, etc) associated with the set of WLAN APs, 505C. For example, if a particular WLAN AP historically provides good backhaul performance on the weekends but poor performance during weekdays (e.g., due to heavy commercial or office use), the particular WLAN AP may be ranked higher on the weekends and lower on the weekdays. Thus, historical performance data may be used in conjunction with the current local environment information (as well as the current time) to predict how well the visible WLAN APs will perform. As an example, the historical performance information can be based on previously reported performance statistics from UEs that accessed one or more of the set of WLAN APs, as discussed in more detail below with respect to FIG. 8B. UE 1's selection between its visible WLAN APs need not be limited to an evaluation of pilot signal strengths of its visible WLAN APs. After ranking the visible WLAN APs, the application server 170 transmits the ranking information of the visible WLAN APs to UE 1, 510C. In an example, 500C through 510C of FIG. 5C correspond to an example implementation of 510A and 515A of FIG. 5A.

Referring to FIG. 5C, UE 1 receives the ranking information (i.e., the WLAN selection assistance information) and attempts to connect to a highest-ranked AP, 515C. UE 1 then determines whether the connection attempt was successful, 520C. If UE 1 determines the connection attempt to the highest-ranked AP was not successful (e.g., which may only be determined after several connection attempt failures) in 520C, the process returns to 515C and repeats for a next highest-ranked AP. Otherwise, the process of FIG. 5C terminates and advances to 530A of FIG. 5A. As will be appreciated, 515C and 520C may repeat until a successful AP connection is achieved by UE 1, or UE 1 has tried and failed to connect to each ranked WLAN AP. In an example, 515C and 520C of FIG. 5C correspond to an example implementation of 520A and 525A of FIG. 5A.

FIG. 5D illustrates an example implementation of 510A through 525A of FIG. 5A in accordance with an embodiment of the invention. Referring to FIG. 5D, assume that the local environment information is indicative of UE 1's location but does not necessarily include a listing of beacon signals that are currently visible by UE 1 (although this is possible).

Referring to FIG. 5D, the application server 170 determines a set of WLAN APs in proximity to UE 1 (e.g., 500 meters, 1 mile, etc.) based on the local environment information, 500D. The set of WLAN APs determined at 500D are not necessarily in range of UE 1, but are fairly close to UE 1. The ranking of WLAN APs discussed with respect to 505C of FIG. 5C is optional, such that the set of proximate WLAN APs determined at 500D may or may not be ranked.

After determining the set of WLAN APs in 500D, the application server 170 determines navigation information sufficient to permit a user of UE 1 to navigate to any of the set of WLAN APs, 505D. For example, if UE 1 has its own turn-by-turn navigation application, the navigation information determined at 505D can correspond to a street address or geographic coordinate for each WLAN AP. In another example, the navigation information determined at 505D can correspond to a map or turn-by-turn directions by which the user of UE 1 can figure out how to move to the WLAN APs. After determining the navigation information at 505D, the application server 170 transmits a list of the proximate WLAN APs along with their associated navigation information to UE 1, 510D. In an example, 500D through 510D of FIG. 5D correspond to an example implementation of 510A and 515A of FIG. 5A.

Referring to FIG. 5D, UE 1 receives the list of proximate WLAN APs along with the associated navigation information (i.e., the WLAN selection assistance information), and UE 1 prompts the user to select one of the proximate WLAN APs, after which the user selects one of the proximate WLAN APs, 515D. For example, each of the WLAN APs may be presented to the user in association with a distance or navigation time, a cost of accessing the WLAN APs, an available bandwidth or waiting time at the WLAN APs, etc. After receiving the user's selection of one of the proximate WLAN APs, UE 1 provides the user with directions to the selected WLAN AP based on the associated navigation information, 520D (e.g., the address or coordinate of the selected WLAN AP may be input into a turn-by-turn navigation application on UE 1, a map showing UE 1's current location and the selected WLAN AP may be displayed on UE 1, etc.). In an example, 515D and 520D of FIG. 5D correspond to an example implementation of 520A of FIG. 5A.

Next, assume that the user of UE 1 moves towards the selected WLAN AP based on the navigation information (e.g., alternatively, it is possible that the selected WLAN AP is already in range and no movement is necessary). Eventually, UE 1 detects the selected WLAN AP, 525D, and then connects to the selected WLAN AP, 530D. In an example, 525D and 530D of FIG. 5D correspond to an example implementation of 525A of FIG. 5A.

In FIGS. 5A and 5B, UE 1 is responsible for monitoring local environment information and then reporting the monitored local environment information to the application server 170, which then uses the local environment information of UE 1 to calculate an estimated duration that UE 1 will remain connected to a given WLAN AP. Information based on the estimated duration (e.g., a file size threshold indicating how much data UE 1 can receive via its current WLAN AP connection) can then be advertised to UEs 2 . . . N. However, in another embodiment, the estimated duration of UE 1's connection to the given WLAN AP can be calculated at UE 1 itself instead of the application server 170, as will be described below with respect to FIG. 5E.

FIG. 5E illustrates a process of establishing a connection to a given WLAN AP based on WLAN AP selection assistance information and then advertising the connection in accordance with another embodiment of the invention. In particular, FIG. 5E relates to an embodiment whereby an estimated duration of a given UE's (“UE 1”) connection to the WLAN AP is calculated UE 1 instead of at the application server 170 (as in FIG. 5A). Also, in FIG. 5E, UE 1 uses the local environment information to select a WLAN AP for its connection on its own, without WLAN selection assistance information received from the application server 170.

Referring to FIG. 5E, UE 1 monitors local environment information, 500E (e.g., as in 500A of FIG. 5A). After monitoring the local environment information in 500E, instead or reporting the local environment information to the application server 170 to request WLAN selection assistance information, UE 1 selects a given WLAN AP (“AP 1”) based on the local environment information and then connects to AP 1, 505E. While not explicitly shown in FIG. 5E, AP 1 may be visible when selected by the user of UE 1 in 505E, or alternatively, AP 1 may be out-of-range when selected and the UE 1 may prompt the user to navigate towards AP 1. Also, AP 1 can be selected based on WLAN selection assistance information that is received from the application server 170, or alternatively can be selected independently by UE 1 via some other mechanism. In 510E, UE 1 estimates a duration that UE 1 is expected to remain connected to AP 1 based on (i) the local environment information from 500E and/or (ii) historical information. As will be appreciated, 510E of FIG. 5E is similar to 535A of FIG. 5A except for being performed at UE 1 instead of the application server 170.

Referring to FIG. 5E, after calculating the estimated duration in 510E, UE 1 advertises its connection to AP 1 based on the estimated duration to one or more UEs 2 . . . N, 515E. In other words, UE 1 notifies the application server 170 of its connection to AP 1 as well as information based on the estimated duration (e.g., the estimated duration itself, an amount of data that UE 1 can reasonably be expected to transmit and/or receive while connected to AP 1, etc.) in 515E. The application server 170 can also notify UEs 2 . . . N regarding UE 1's AP connection, 520E, as discussed above with respect to 540A of FIG. 5A.

FIGS. 6A, 6B and 6C each illustrate a different example of the application server 170 and/or UEs 2 . . . N responding to the advertisement of UE 1's connection to AP 1. In particular, FIG. 6A illustrates an advertisement response example whereby a single UE (“UE 2”) determines to initiate a large file transfer session responsive to UE 1's WLAN AP connection advertisement, FIG. 6B illustrates an advertisement response example whereby multiple UEs (e.g., UEs 2 . . . N, where N>2) determine to initiate a large file transfer session responsive to UE 1's WLAN AP connection advertisement and FIG. 6C illustrates an advertisement response example the application server 170 itself determines to initiate a large file transfer session responsive to UE 1's WLAN AP connection advertisement.

Referring to FIG. 6A, after UE 2 receives the advertisement of UE 1's connection to AP 1 in 540A of FIG. 5A, 545B of FIG. 5B or 520E of FIG. 5E, UE 2 checks whether it has one or more files to send to UE 1 that singly and/or collectively have a size above a threshold (e.g., 10 MB, 200 MB, 1 GB, etc.), 600A. As used herein, the term “size” or “file size” can be used to refer to a data file length (e.g., 2 megabytes, 1.5 gigabytes, 180 kilobytes, etc.), or alternatively can be based on data rate and/or time for streaming-type data. In an example, the threshold used for the determination of 600A can correspond to a size limit of file transfers over the WWAN 400, in an example (e.g., 2 GB in one file transfer session, 1.5 megabits per second for streaming content, etc.). In a further example, UE 2 may determine that the one or more files above the threshold are present if that UE 2 previously queued the one or more files for transmission to UE 1 at a later point in time when UE 1 is WLAN-connected, or alternatively by prompting the user to notify the user of UE 2 that files above the threshold can now be sent to UE 1. If UE 2 has no large files to transmit to UE 2, no large files are transmitted by UE 2 to UE 1, 605A. Otherwise, if UE 2 has one or more large files to transmit to UE 2, the process advances to 610A.

In 610A, UE 1 determines whether the one or more files with the size above the threshold are capable of completing their transmission to UE 1 while UE 1 remains connected to AP 1. For example, the determination of 610A can compare the size of the one or more files with the file transfer threshold conveyed to UE 2 at 545B of FIG. 5B, for example. In another example, UE 2 may estimate the bandwidth of its connection to UE 1 over AP 1 and determine whether the one or more files with the size above the threshold are capable of completing their transmission to UE while UE 1 remains connected to AP 1 based on the estimated duration that UE 1 is expected to remain connected to AP 1. If UE 1 determines that it is unlikely that the one or more files can complete transmission to UE 1 while UE 1 remains connected to AP 1 in 610A, the one or more files are not transmitted by UE 2 to UE 1, 605A. Otherwise, if UE 1 determines that it is likely that the one or more files can complete transmission to UE 1 while UE 1 remains connected to AP 1 in 610A, the one or more files are transmitted by UE 2 to UE 1, 615A.

Referring to FIG. 6B, 600B through 610B correspond to 600A through 610A of FIG. 6A, respectively, except that 600B through 610B are performed at each of UEs 2 . . . N, where N>2. After 610B, assume that at least two of UEs 2 . . . N determine to transmit their respective files to UE 1 while UE 1 remains connected to AP 1. Accordingly, the at least to UEs each transmit, to the application server 170, a request to transmit their respective files to UE 1, 615B. While not shown explicitly in FIG. 6A, UE 2 may have requested (and received) the same permission to transmit to UE 1 prior to the transmission of 615A.

The application server 170 receives the multiple transmission requests from the at least two UEs and prioritizes the transmissions from the at least two UEs, 620B. For example, the prioritization of 620B may be configured to prioritize one of the requesting UEs over other requesting UE(s). In another example, the prioritization of 620B may be configured to prioritize smaller file transfer sessions over larger file transfer sessions (or vice versa). Also in 620B, the application server 170 instructs the at least two UEs to transmit their respective files to UE 1 in accordance with the associated prioritization for their transmissions. In an example, this may mean that one of the requesting UEs delays the start of its file transmission or refrains from sending its file altogether, while another UE initiates its file transfer session with UE 1 immediately. After receiving the prioritization instructions from the application server 170, the at least two UEs selectively transmit their files to UE 1 over the WLAN 420A and AP 1 based on the respective priorities of their transmissions, 625B.

Referring to FIG. 6C, after the application server 170 calculates the estimated duration of UE 1's connection to AP 1 in 535A of FIG. 5A, or after the application server 170 calculates the file transfer threshold in 540B of FIG. 5B, or after the application server 170 receives the advertisement of UE 1's connection to AP 1 in 515E of FIG. 5E, the application server 170 checks whether it has one or more files to send to UE 1 that singly and/or collectively have a size above a threshold (e.g., 10 MB, 200 MB, 1 GB, etc.), 600C. For example, the threshold used for the determination of 600C can correspond to a size limit of file transfers over the WWAN 400, in an example, such that the application server 170 previously queued the one or more files for transmission to UE 1 at later point in time when UE 1 is WLAN-connected. 600C, and also 605C and 610C, correspond to 600A through 610A of FIG. 6A, respectively, except that 600C through 610C are performed at the application server 170 instead of UE 1.

After determining to transmit at least one ‘large’ file (i.e., a file with a size above the threshold from 600C) to UE 1, the application server 170 prioritizes the transmissions of the file(s) for transmission, if necessary, 615C (e.g., so that higher-priority files are scheduled before lower-priority files, so that smaller files are transmitted before larger files to ensure some of the files complete transmission, etc.). After optionally prioritizing the files for transmission to UE 1, the application server 170 transmits the file(s) to UE 1 over the WLAN 420A via AP 1, 620C.

As will be appreciated by one of ordinary skill in the art, FIGS. 5A through 5E are described under the assumption that UE 1 monitors its local environment to determine information by which a WLAN AP can be selected, connected to, and then advertised, and FIG. 6A through illustrate example continuations of these processes. FIGS. 7A through 7C, which are described next, are directed to different examples of triggering mechanisms for FIGS. 5A through 5E. In particular, the procedures of FIGS. 5A through 5E can be triggered either by (i) a mobile-originated large file transfer (e.g., discussed in more detail below with respect to FIG. 7A), (ii) a mobile-terminated large file transfer that originates from another UE (e.g., discussed in more detail below with respect to FIG. 7B), or (iii) a server-originated large file transfer (e.g., discussed in more detail below with respect to FIG. 7C).

Referring to FIG. 7A, while UE 1 is not connected to WLAN 420A or 420B, UE 1 determines to transmit file(s) with a size above a threshold to the application server 170 and/or to one or more of UEs 2 . . . N, 700A. The determination of 700A triggers UE 1 to begin execution of FIG. 5A or FIG. 5E in 705A. After the execution of FIG. 5A or FIG. 5E completes in 705A, it will be appreciated that UE 1's connection to AP 1 has been advertised such that the application server 170 and/or UEs 2 . . . N are on-notice regarding potential large file transfers from UE 1. Accordingly, UE 1 transmits the file(s) over AP 1 of the WLAN 420A to the application server 170 and/or UEs 2 . . . N in 710A. As will be appreciated, the trigger for the execution of FIG. 5A or 5E in FIG. 7A is data to be transmitted by UE 1, such that FIG. 7A corresponds to an example of a mobile-originated large file transfer.

Referring to FIG. 7B, while UE 1 is not connected to WLAN 420A or 420B, UE 2 determines to transmit file(s) with a size above a threshold to UE 1, 700B. UE 2 transmits an indication of its desire to transmit one or more large files to UE 1 to the application server 170, 705B. The application server 170 receives the request and prompts UE 1 to monitor local environment information so that UE 1 can be transitioned to an appropriate WLAN AP, 710B. This prompt could be over the WWAN connection. Responsive to the prompt from the application server 170, UE 1 begins execution of FIG. 5A or FIG. 5E in 715B. After the execution of FIG. 5A or FIG. 5E completes in 715B, it will be appreciated that UE 1's connection to AP 1 has been advertised such that the application server 170 and/or UE 2 know that UE 1 is now set-up to receive its large file(s). Accordingly, after 715B, the process of FIG. 7B can advance to FIG. 6A or FIG. 6B whereby UE 2 can attempt to send its large file(s) to UE 1. As will be appreciated, the trigger for the execution of FIG. 5A or 5E in FIG. 7B is data to be transmitted to UE 1 by another UE, such that FIG. 7B corresponds to an example of a mobile-terminated large file transfer.

Referring to FIG. 7C, while UE 1 is not connected to WLAN 420A or 420B, the application server 170 determines to transmit file(s) with a size above a threshold to UE 1, 700C. The application server 170 prompts UE 1 to monitor local environment information so that UE 1 can be transitioned to an appropriate WLAN AP, 705C. Responsive to the prompt from the application server 170, UE 1 begins execution of FIG. 5A or FIG. 5E in 710C. After the execution of FIG. 5A or FIG. 5E completes in 710C, it will be appreciated that UE 1's connection to AP 1 has been advertised such that the application server 170 know that UE 1 is now set-up to receive its large file(s). Accordingly, after 710C, the process of FIG. 7C can advance to FIG. 6C whereby the application server 170 can attempt to send its large file(s) to UE 1. As will be appreciated, the trigger for the execution of FIG. 5A or 5E in FIG. 7C is data to be transmitted to UE 1 by the application server 170, such that FIG. 7C corresponds to an example of a mobile-terminated large file transfer.

While the above-described embodiments generally attempt to initiate file transfer sessions with UE 1 that can be completed before UE 1 is disconnected from its WLAN AP, it will be appreciated that it is not possible to guarantee completion of the file transfer session(s). Accordingly, FIG. 8A is directed to an embodiment that shows one example of a recovery from WLAN coverage loss at UE 1.

Referring to FIG. 8A, assume that UE 1 is engaged in a file transfer session with the application server 170 and/or UEs 2 . . . N over AP 1 of the WLAN 420A, 800. For example, the file transfer session of 800 can correspond to a mobile-originated file transfer session whereby UE 1 is transmitted data to the application server 170 and/or UEs 2 . . . N (e.g., as in FIG. 7A), to a mobile-terminated file transfer session whereby another UE is transmitting data to UE 1 (e.g., as in FIG. 7B) or to a mobile-terminated file transfer session whereby the application server 170 is transmitting data to UE 1 (e.g., as in FIG. 7C).

During the file transfer session of 800, UE 1 detects an actual or imminent coverage loss with respect to AP 1 and the WLAN 420A, 805. UE 1 notifies the application server 170 of the actual or imminent coverage loss over the WWAN 400, 810. The application server 170 thereby suspends or pauses the file transfer session over the WLAN 420A, 815. While not shown in FIG. 8A, if only a small portion of data remains to be sent to UE 1, the application server 170 may simply transmit the remaining data over the WWAN 400. Also, while the application server 170 is shown as suspending the file transfer session in 815, it will be appreciated that the suspension may also involve the UE 1 refraining from sending additional data over the WLAN 420A (e.g., in a mobile-originated scenario) or UEs 2 . . . N refraining from sending data to UE 1 (e.g., in a mobile-terminated scenario with UEs 2 . . . N providing the source data).

At some later point in time, UE 1 regains its WLAN connection with a connection to one of APs 2 . . . N in WLAN 420B, 820. While not shown in FIG. 8A, the reconnection of 820 may be the result of WLAN selection assistance information from the application server 170, in an example, based on local environment monitors after the WLAN coverage loss. UE 1 notifies the application server 170 over its new WLAN connection regarding the WLAN connection re-establishment, 825, and the application server 170 determines to resume the file transfer session, 830. Accordingly, the file transfer session is resumed at 835.

While FIG. 8A illustrates an example of recovering from a scenario where a connection to a WLAN AP is lost altogether, FIG. 8B is directed to a scenario whereby the connection to the WLAN AP is maintained but the performance is inadequate.

Referring to FIG. 8B, assume that UE 1 is engaged in a file transfer session with the application server 170 and/or UEs 2 . . . N over AP 1 of the WLAN 420A, 800B. For example, the file transfer session of 800B can correspond to a mobile-originated file transfer session whereby UE 1 is transmitted data to the application server 170 and/or UEs 2 . . . N (e.g., as in FIG. 7A), to a mobile-terminated file transfer session whereby another UE is transmitting data to UE 1 (e.g., as in FIG. 7B) or to a mobile-terminated file transfer session whereby the application server 170 is transmitting data to UE 1 (e.g., as in FIG. 7C).

During the file transfer session of 800B, UE 1 monitors performance statistics (e.g., data rate, latency, etc.) associated with its connection to AP 1, and UE 1 periodically reports the performance statistics to the application server 170, 805B. The application server 170 receives the performance statistics and updates its tracking of AP 1's backhaul performance and also determines whether the current level of performance provided by AP 1 to UE 1 is sufficient, 810B. If AP 1's performance is determined to be sufficient in 810B, the file transfer session continues over AP 1. Otherwise, if AP 1's performance is determined to be insufficient in 810B, the application server 170 generates updated WLAN AP selection assistance information that takes AP 1's poor performance into account, 815B (e.g., similar to 510A of FIG. 5A). The application server 170 transmits the updated WLAN AP selection assistance information to UE 1 (e.g., over AP 1, or alternatively over the WWAN 400), 820B. UE 1 selects and then connects a new WLAN AP based on the updated WLAN AP selection assistance information, 825B (e.g., potentially, after some navigation). UE 1 notifies the application server 170 of its new WLAN AP connection, 830B, after which the file transfer session continues over the new WLAN AP, 835B. After the file transfer session is over, UE 1 can report the “final” performance statistics associated with its file transfer session, 840B. The performance statistic reports function as feedback by which the application server 170 can refine the manner in which future WLAN AP selection assistance information is generated. Also, while not shown as part of FIGS. 5A through 7C, the reporting of the performance statistics can be performed in conjunction with any of the above-noted embodiments.

As will be appreciated by one of ordinary skill in the art, FIGS. 5A through 8B are described under the assumption that the WLAN NAT and/or firewall as well as the WWAN NAT and/or firewall can be traversed to permit the file transfer sessions between the application server 170 and UE 1 over the WLAN. For example, the file transmission from UE 2 through the application server 170 to UE 1 over the WLAN 420A as shown in 615A of FIG. 6A is described without specific mention to the NAT and/or firewalls that are traversed to accommodate the file transmission. FIGS. 9A and 9B illustrate example NAT and/or firewall traversal procedures that may be performed, if necessary, to traverse the above-noted NAT and/or firewalls and thereby facilitate the above-described file-transfer sessions. More specifically, FIG. 9A illustrates a process by which mobile-originated data can be sent by UE 1 irrespective of the NATs and/or firewalls in the WLAN 420A or WWAN 400, and FIG. 9B illustrates a process by which mobile-terminated data can be sent to UE 1 irrespective of the NATs and/or firewalls in the WLAN 420A or WWAN 400.

Referring to FIG. 9A, UE 1 determines whether to transmit a file to the application server 170 with a size above a threshold, 905A (e.g., as in 700A of FIG. 7). UE 1 establishes a connection to AP 1 (e.g., as in 525A of FIG. 5A, 505E of FIG. 5E, etc.) and obtains a private IP address, 910A. The remainder of FIG. 9A operates under the assumption that UE 1 is aware or at least believes there is a high likelihood that NAT 430, WLAN firewall 435 and WWAN firewall 405 will function as obstructions to a direct attempt to send the file to the application server 170 via the WLAN 420. Accordingly, the NAT/firewall bypass procedures discussed below are based upon this assumption.

Referring to FIG. 9A, after UE 1 connects to AP 1 of the WLAN 420A in 910A, UE 1 requests its public IP address from the file server 410 using a protocol such as Session Traversal Utilities for NAT (STUN). STUN is defined in RFC 5389 and provides a means for an endpoint to determine the IP address and port allocated by a NAT that corresponds to its private IP address and port. STUN, along with some extensions, may also be used to keep a NAT binding alive or the like, and to perform connectivity checks between two endpoints. UE 1 uses a binary signaling protocol to implement a protocol (e.g., STUN) in order to request its public IP address, 915A, and also to maintain its IP address and port association. The file server 410 then sends the public IP address to UE 1, 920A. As will be appreciated, the public IP address corresponds to the IP address used by entities external to the WLAN 420A to send data to/from the WLAN 420A, whereas the private IP address is the IP address used for entities within the WLAN 420A itself. In addition to obtaining the public IP address for the WLAN 420A, UE 1 monitors the behavior of the NAT 430 in order to determine additional WLAN connection information, 925A. For example, in 925A, UE 1 can exchange IP data packets with the file server 410 while changing the source port and/or destination port of the IP data packets. In this manner, UE 1 can determine the relationship between the internal or private IP address and port number of UE 1 within the WLAN 420A with the public IP address and port number for the WLAN 420A. For example, UE 1 can send two or more follow-up queries to the file server 410 to determine its public IP and port for that specific private IP to test the NAT behavior. In each of the queries, the UE 1 can change the source port in the UDP header. UE 1 can compare its request and the responses received from the file server 410 to determine a relation used by the NAT to map the 4 tuple (e.g., private IP address of UE 1, UE 1's port number, the file server 410's IP address and the file server 410's port number) to the UE 1's public IP address and port numbers as assigned by the NAT. For example, the UE 1's determination at 925A can correspond to figuring out that the NAT 430 is merely adding a fixed number (e.g., 10000, etc.) to the ports selected as long as the port numbers are within the allowable limits, based on the messages exchanged as noted above.

After UE 1 determines the public IP address (915A and 920A) as well as the NAT behavior related to the correspondence between UE 1's private IP address and port number to the public IP address and port number (925A), UE 1 uses this information to punch holes through the NAT 430 and WLAN firewall 435 of the WLAN 420A in an attempt to send the file to the application server 170, 930A. In 930A, assume that UE 1 is successful in exporting the file outside of the WLAN 420A and to the Internet 175, but that the WWAN firewall 405 blocks the file transfer. Accordingly, UE 1 determines that the attempt to transmit the file over the WLAN 420A to the application server 170 has failed due to the WWAN firewall 405, 935A.

Accordingly, UE 1 transmits its WLAN connection information to the application server 170 over its WWAN connection, 940A. For example, the WLAN connection information sent to the application server 170 in 940A can include the WLAN's speed or bandwidth, the WLAN's latency, the WLAN's packet drop rate, and/or other performance information associated with the WLAN connection to WLAN 420A.

The application server 170 receives the WLAN connection information and then punches holes through its own WWAN firewall 405 within the WWAN 400 so as to send an ACK to UE 1's message from 940A, 945A. Because the ACK is generated within the firewalled WWAN 400, the ACK passes through the WWAN firewall 405 and is then sent to UE 1 over the WLAN 420A, 950A. Also in 945A, along with punching the holes in the WWAN firewall 405, the application server 170 opens the WWAN firewall 405 to permit bi-directional traffic to pass-through the WWAN firewall 405 between UE 1 and the application server 170 until expiration of a given WWAN firewall timer. Thus, after opening the WWAN firewall 405 to permit bi-directional traffic between UE 1 and the application server 170, the ACK sent back to UE 1 functions to notify UE 1 that another attempt to transmit data through the WWAN firewall 405 to the applicant server 170 will be successful.

Accordingly, UE 1 makes another attempt to send the file to the application server 170 via the WLAN 420A in 955A. The attempt of 955A is successful because both the WLAN firewall 435 and WWAN firewall 405 are now open to traffic being exchanged between UE 1 and the application server 170. As will be appreciated, FIG. 9A shows how mobile-originated data can be sent by UE 1 to the application server 170 (and/or UEs 2 . . . N through the application server 170). Thus, the file that is transmitted in 955A from UE 1 can correspond to the notification of 530A of FIG. 5A, in an example, or the large file transmission of 710A of FIG. 7A, in another example.

FIG. 9B illustrates a process of sending data from the application server 170 (or UEs 2 . . . N through the application server 170) to UE 1 within the wireless communications system of FIG. 4 in accordance with another embodiment of the invention. FIG. 9B is similar in some respects to FIG. 9A, except that FIG. 9A illustrates a process of uploading a file from UE 1 to the application server 170, whereas FIG. 9B illustrates a process of downloading a file from the application server 170 to UE 1.

Accordingly, referring to FIG. 9B, the application server 170 determines whether to transmit a file to UE 1 over the WLAN 420A, 905B (e.g., in response to a self-determination as shown in 600C of FIG. 6C or 700C of FIG. 7C, or on behalf of some other entity as shown in 615A of FIG. 6A, 615B through 625B of FIG. 6B, and/or 705B and 710B of FIG. 7B). In the embodiment of FIG. 9B, assume that the application server 170 determines to transmit the file over the WLAN 420A, such that the application server 170 notifies UE 1, over the WWAN 400, of the application server 170's intent to transmit a relatively large file to the UE 1, 910B. For example, the notification of 910B may correspond to the prompt of 710B of FIG. 7B or the prompt of 705C of FIG. 7C.

Referring to FIG. 9B, UE 1 receives the notification from the application server 170, after which 920B through 935B substantially correspond to 910A through 925A, respectively, of FIG. 9A, and as such will not be described further for the sake of brevity. In 940B, UE 1 punches holes through the WLAN NAT 430 and firewall 435 in order to permit the file from the application server 170 to pass-through the WLAN firewall 435. In 945B, UE 1 transmits the WLAN connection information to the application server 170, as in 940B of FIG. 9B. The application server 170 receives the WLAN connection information from UE 1 and then transmits or downloads the file to UE 1 over the WLAN 420A, 950B. As will be appreciated, FIG. 9B shows how mobile-terminated data can be sent to UE 1. Thus, the file that is transmitted in 950B to UE 1 can correspond to the large file transmissions of 615A, 625B or 620C, or alternatively to the prompts of 710B or 705C.

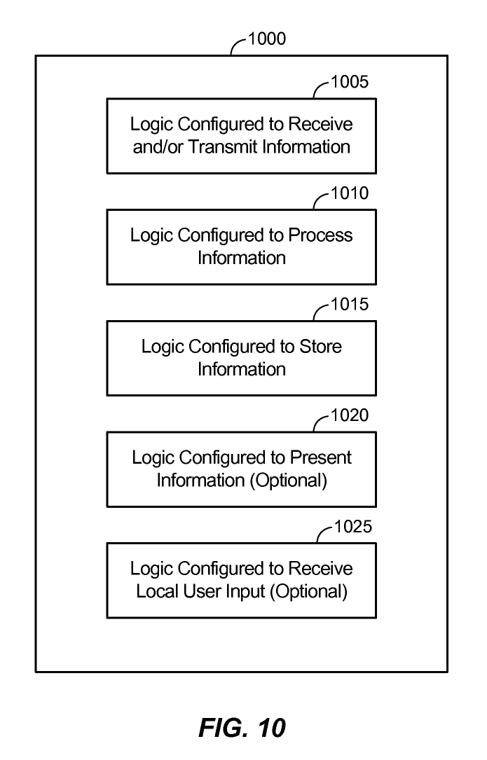

FIG. 10 illustrates a communication device 1000 that includes logic configured to perform functionality in accordance with an embodiment of the invention. The communication device 1000 can correspond to any of the above-noted communication devices, including but not limited to UEs 102, 108, 110, 112 or 200, Node Bs or base stations 120, the RNC or base station controller 122, a packet data network end-point (e.g., SGSN 160, GGSN 165, etc.), any of the servers 170 through 186, etc. Thus, communication device 1000 can correspond to any electronic device that is configured to communicate with (or facilitate communication with) one or more other entities over a network.

Referring to FIG. 10, the communication device 1000 includes logic configured to receive and/or transmit information 1005. In an example, if the communication device 1000 corresponds to a wireless communications device (e.g., UE 200, Node B 124, etc.), the logic configured to receive and/or transmit information 1005 can include a wireless communications interface (e.g., Bluetooth, WiFi, 2G, 3G, etc.) such as a wireless transceiver and associated hardware (e.g., an RF antenna, a MODEM, a modulator and/or demodulator, etc.). In another example, the logic configured to receive and/or transmit information 1005 can correspond to a wired communications interface (e.g., a serial connection, a USB or Firewire connection, an Ethernet connection through which the Internet 175 can be accessed, etc.). Thus, if the communication device 1000 corresponds to some type of network-based server (e.g., SGSN 160, GGSN 165, application server 170, etc.), the logic configured to receive and/or transmit information 1005 can correspond to an Ethernet card, in an example, that connects the network-based server to other communication entities via an Ethernet protocol. In a further example, the logic configured to receive and/or transmit information 1005 can include sensory or measurement hardware by which the communication device 1000 can monitor its local environment (e.g., an accelerometer, a temperature sensor, a light sensor, an antenna for monitoring local RF signals, etc.). The logic configured to receive and/or transmit information 1005 can also include software that, when executed, permits the associated hardware of the logic configured to receive and/or transmit information 1005 to perform its reception and/or transmission function(s). However, the logic configured to receive and/or transmit information 1005 does not correspond to software alone, and the logic configured to receive and/or transmit information 1005 relies at least in part upon hardware to achieve its functionality.

Referring to FIG. 10, the communication device 1000 further includes logic configured to process information 1010. In an example, the logic configured to process information 1010 can include at least a processor. Example implementations of the type of processing that can be performed by the logic configured to process information 1010 includes but is not limited to performing determinations, establishing connections, making selections between different information options, performing evaluations related to data, interacting with sensors coupled to the communication device 1000 to perform measurement operations, converting information from one format to another (e.g., between different protocols such as .wmv to .avi, etc.), and so on. For example, the processor included in the logic configured to process information 1010 can correspond to a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The logic configured to process information 1010 can also include software that, when executed, permits the associated hardware of the logic configured to process information 1010 to perform its processing function(s). However, the logic configured to process information 1010 does not correspond to software alone, and the logic configured to process information 1010 relies at least in part upon hardware to achieve its functionality.

Referring to FIG. 10, the communication device 1000 further includes logic configured to store information 1015. In an example, the logic configured to store information 1015 can include at least a non-transitory memory and associated hardware (e.g., a memory controller, etc.). For example, the non-transitory memory included in the logic configured to store information 1015 can correspond to RAM memory, flash memory, ROM memory, EPROM memory, EEPROM memory, registers, hard disk, a removable disk, a CD-ROM, or any other form of storage medium known in the art. The logic configured to store information 1015 can also include software that, when executed, permits the associated hardware of the logic configured to store information 1015 to perform its storage function(s). However, the logic configured to store information 1015 does not correspond to software alone, and the logic configured to store information 1015 relies at least in part upon hardware to achieve its functionality.

Referring to FIG. 10, the communication device 1000 further optionally includes logic configured to present information 1020. In an example, the logic configured to present information 1020 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communication device 1000. For example, if the communication device 1000 corresponds to UE 200 as shown in FIG. 3, the logic configured to present information 1020 can include the display 224. In a further example, the logic configured to present information 1020 can be omitted for certain communication devices, such as network communication devices that do not have a local user (e.g., network switches or routers, remote servers, etc.). The logic configured to present information 1020 can also include software that, when executed, permits the associated hardware of the logic configured to present information 1020 to perform its presentation function(s). However, the logic configured to present information 1020 does not correspond to software alone, and the logic configured to present information 1020 relies at least in part upon hardware to achieve its functionality.

Referring to FIG. 10, the communication device 1000 further optionally includes logic configured to receive local user input 1025. In an example, the logic configured to receive local user input 1025 can include at least a user input device and associated hardware. For example, the user input device can include buttons, a touch-screen display, a keyboard, a camera, an audio input device (e.g., a microphone or a port that can carry audio information such as a microphone jack, etc.), and/or any other device by which information can be received from a user or operator of the communication device 1000. For example, if the communication device 1000 corresponds to UE 200 as shown in FIG. 3, the logic configured to receive local user input 1025 can include the display 224 (if implemented a touch-screen), keypad 226, etc. In a further example, the logic configured to receive local user input 1025 can be omitted for certain communication devices, such as network communication devices that do not have a local user (e.g., network switches or routers, remote servers, etc.). The logic configured to receive local user input 1025 can also include software that, when executed, permits the associated hardware of the logic configured to receive local user input 1025 to perform its input reception function(s). However, the logic configured to receive local user input 1025 does not correspond to software alone, and the logic configured to receive local user input 1025 relies at least in part upon hardware to achieve its functionality.

Referring to FIG. 10, while the configured logics of 1005 through 1025 are shown as separate or distinct blocks in FIG. 10, it will be appreciated that the hardware and/or software by which the respective configured logic performs its functionality can overlap in part. For example, any software used to facilitate the functionality of the configured logics of 1005 through 1025 can be stored in the non-transitory memory associated with the logic configured to store information 1015, such that the configured logics of 1005 through 1025 each performs their functionality (i.e., in this case, software execution) based in part upon the operation of software stored by the logic configured to store information 1005. Likewise, hardware that is directly associated with one of the configured logics can be borrowed or used by other configured logics from time to time. For example, the processor of the logic configured to process information 1010 can format data into an appropriate format before being transmitted by the logic configured to receive and/or transmit information 1005, such that the logic configured to receive and/or transmit information 1005 performs its functionality (i.e., in this case, transmission of data) based in part upon the operation of hardware (i.e., the processor) associated with the logic configured to process information 1010. Further, the configured logics or “logic configured to” of 1005 through 1025 are not limited to specific logic gates or elements, but generally refer to the ability to perform the functionality describe herein (either via hardware or a combination of hardware and software). Thus, the configured logics or “logic configured to” of 1005 through 1025 are not necessarily implemented as logic gates or logic elements despite sharing the word “logic”. Other interactions or cooperation between the configured logics 1005 through 1025 will become clear to one of ordinary skill in the art from a review of the embodiments described above.

While the embodiments above have been described with reference to GPRS architecture in 2G or W-CDMA-based 3G networks, it will be appreciated that other embodiments can be directed to other types of network architectures and/or protocols. For example, the embodiments described above can be carried over to a Long-Term Evolution (LTE) network, whereby a combination of the RNC and the SGSN maps to a Mobility Management Entity (MME) for control plane and Serving Gateway (S-GW) for user plane traffic in LTE, the Activate PDP Context Request message maps to an Activate default Bearer Request or Public Data Network (PDN) Connectivity Request message in LTE, the PDP context maps to an Evolved Packet System (EPS) Bearer in LTE, and the Home Location Register (HLR) settings map to Home Subscriber Service (HSS) settings in LTE, the GGSN maps to the Packet Data Network (PDN) Gateway, and so on. APNs are used both in UMTS/HSPA and LTE networks for identifying packet data networks (PDNs) and the services within the PDNs.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method of exchanging data between a User Equipment (UE) configured to connect to a Wireless Local Area Network (WLAN) and a Wireless Wide Area Network (WWAN)-based application server, comprising:
monitoring a local environment of the UE;
transmitting local environment information to the application server based on the monitoring;
receiving, in response to the transmission of the local environment information, WLAN AP selection assistance information that includes at least (i) a list of WLAN access points (APs) that are in a vicinity of the UE and (ii) navigation information by which the UE can navigate to the listed WLAN APs;
determining a selection of one of the listed WLAN APs; and
providing a user of the UE with directions to the selected WLAN AP based on the selected WLAN AP's associated navigation information.

2. The method of claim 1, wherein the listed WLAN APs are ranked based at least in part on an expectation of their backhaul performance.

3. The method of claim 1, wherein the UE is outside a coverage area associated with at least one of the listed WLAN APs.

4. The method of claim 1, further comprising:
determining, at the UE, to transmit mobile-originated data with a size or data-rate above a threshold,
wherein the monitoring step is triggered by the determination to transmit the mobile-originated data in order to facilitate a transition of the UE to the WLAN so that the mobile-originated data can be transmitted over the WLAN.

5. The method of claim 1, further comprising:
receiving, at the UE, an indication that mobile-terminated data with a size or data-rate above a threshold is available for transmission to the UE,
wherein the monitoring step is triggered by the received indication in order to facilitate a transition of the UE to the WLAN so that the mobile-terminated data can be received over the WLAN.

6. The method of claim 5, wherein the mobile-terminated data originates from the application server or one or more other UEs.

7. The method of claim 1, further comprising:
connecting to the selected WLAN AP; and
advertising the connection to the selected WLAN AP to the application server and/or one or more other UEs.

8. A method of exchanging data between a User Equipment (UE) configured to connect to a Wireless Local Area Network (WLAN) and a Wireless Wide Area Network (WWAN)-based application server, comprising:
receiving information indicative of a local environment of the UE;
determining a set of WLAN access points (APs) that are in a vicinity of the UE based on the local environment information;
generating, based on the determined set of WLAN APs, a list of WLAN APs to be sent to the UE;
generating WLAN AP selection assistance information that includes at least (i) the list of WLAN APs and (ii) navigation information by which the UE can navigate to the listed WLAN APs; and
transmitting the WLAN AP selection assistance information to the UE.

9. The method of claim 8, wherein the generation of the list of WLAN APs includes ranking the set of WLAN APs based on a backhaul performance expectation of the set of WLAN APs.

10. The method of claim 8, wherein the generation of the list of WLAN APs includes excluding, from the list of WLAN APs, one or more of the set of WLAN APs based on a backhaul performance expectation of the one or more of the set of WLAN APs.

11. A method of exchanging data between a User Equipment (UE) configured to connect to a Wireless Local Area Network (WLAN) and a Wireless Wide Area Network (WWAN)-based application server, comprising:
determining that the UE is connected to a given WLAN access point (AP);
calculating an estimated duration that the UE is expected to remain connected to the given WLAN AP; and
advertising the UE's connection to the given WLAN AP and information associated with the estimated duration to prompt one or more external entities to exchange an amount of data with the UE that is based on the estimated duration.

12. The method of claim 11, further comprising:
determining local environment information associated with the UE;
determining historical information associated with the UE and/or the given WLAN AP,
wherein the calculation of the estimated duration is based on the local environment information and/or the historical information.

13. The method of claim 11, further comprising:
calculating an amount of data that can be exchanged with the UE while the UE is connected to the given WLAN AP based on the estimated duration and an estimation of bandwidth for the given WLAN AP,
wherein the advertised information includes the calculated amount of data.

14. The method of claim 11, wherein the determining, calculating and advertising steps are performed at the UE.

15. The method of claim 11, wherein the determining, calculating and advertising steps are performed at the application server.

16. A method of exchanging data between a User Equipment (UE) configured to connect to a Wireless Local Area Network (WLAN) and a Wireless Wide Area Network (WWAN)-based application server, comprising:
receiving an advertisement indicating (i) that the UE is connected to a given WLAN AP and (ii) information associated with an estimated duration that the UE is expected to remain connected to the given WLAN AP; and
determining whether to transmit one or more files with a size above a threshold based on the received advertisement.

17. The method of claim 16, wherein the threshold corresponds to an amount of data that can be exchanged with the UE while the UE is connected to the given WLAN AP.

18. The method of claim 17, wherein the threshold is included in the advertised information.

19. The method of claim 16, wherein the determining step includes:
comparing the size of the one or more files with the threshold;
determining to transmit the one or more files if the comparison indicates that the size of the one or more files is less than the threshold; and
determining not to transmit the one or more files if the comparison indicates that the size of the one or more files is not less than the threshold.

20. The method of claim 16, wherein the receiving and determining steps are performed at the application server.

21. The method of claim 16, wherein the receiving and determining steps are performed at another UE.

22. The method of claim 21, wherein the determining step determines to transmit one or more files, further comprising:
requesting permission to transmit the one or more files to the UE;
receiving, from the application server, information indicative of a priority of the another UE's request; and
selectively transmitting the one or more files to the UE based on the priority.

23. A User Equipment (UE) configured to connect to a Wireless Local Area Network (WLAN) and to exchange data with a Wireless Wide Area Network (WWAN)-based application server, comprising:
means for monitoring a local environment of the UE;
means for transmitting local environment information to the application server based on the monitoring;
means for receiving, in response to the transmission of the local environment information, WLAN AP selection assistance information that includes at least (i) a list of WLAN access points (APs) that are in a vicinity of the UE and (ii) navigation information by which the UE can navigate to the listed WLAN APs;
means for determining a selection of one of the listed WLAN APs; and
means for providing a user of the UE with directions to the selected WLAN AP based on the selected WLAN AP's associated navigation information.

24. An application server that is based in a Wireless Wide Area Network (WWAN) and is configured to exchange data with a User Equipment (UE) configured to connect to a Wireless Local Area Network (WLAN), comprising:
means for receiving information indicative of a local environment of the UE;
means for determining a set of WLAN access points (APs) that are in a vicinity of the UE based on the local environment information;
means for generating, based on the determined set of WLAN APs, a list of WLAN APs to be sent to the UE;
means for generating WLAN AP selection assistance information that includes at least (i) the list of WLAN APs and (ii) navigation information by which the UE can navigate to the listed WLAN APs; and
means for transmitting the WLAN AP selection assistance information to the UE.

25. A communication entity configured to exchange data between a User Equipment (UE) and a Wireless Wide Area Network (WWAN)-based application server over a Wireless Local Area Network (WLAN), comprising:
means for determining that the UE is connected to a given WLAN access point (AP);
means for calculating an estimated duration that the UE is expected to remain connected to the given WLAN AP; and
means for advertising the UE's connection to the given WLAN AP and information associated with the estimated duration to prompt one or more external entities to exchange an amount of data with the UE that is based on the estimated duration.

26. The communication entity of claim 25, wherein the communication entity corresponds to the UE.

27. The communication entity of claim 25, wherein the communication entity corresponds to the application server.

28. A communication entity configured to exchange data between a User Equipment (UE) and a Wireless Wide Area Network (WWAN)-based application server over a Wireless Local Area Network (WLAN), comprising:
means for receiving an advertisement indicating (i) that the UE is connected to a given WLAN AP and (ii) information associated with an estimated duration that the UE is expected to remain connected to the given WLAN AP; and
means for determining whether to transmit one or more files with a size above a threshold based on the received advertisement.

29. The communication entity of claim 28, wherein the communication entity corresponds to a given UE to which the advertisement is directed.

30. The communication entity of claim 28, wherein the communication entity corresponds to the application server.

31. A User Equipment (UE) configured to connect to a Wireless Local Area Network (WLAN) and to exchange data with a Wireless Wide Area Network (WWAN)-based application server, comprising:
logic configured to monitor a local environment of the UE;
logic configured to transmit local environment information to the application server based on the monitoring;
logic configured to receive, in response to the transmission of the local environment information, WLAN AP selection assistance information that includes at least (i) a list of WLAN access points (APs) that are in a vicinity of the UE and (ii) navigation information by which the UE can navigate to the listed WLAN APs;
logic configured to determine a selection of one of the listed WLAN APs; and
logic configured to provide a user of the UE with directions to the selected WLAN AP based on the selected WLAN AP's associated navigation information.

32. An application server that is based in a Wireless Wide Area Network (WWAN) and is configured to exchange data with a User Equipment (UE) configured to connect to a Wireless Local Area Network (WLAN), comprising:
logic configured to receive information indicative of a local environment of the UE;
logic configured to determine a set of WLAN access points (APs) that are in a vicinity of the UE based on the local environment information;
logic configured to generate, based on the determined set of WLAN APs, a list of WLAN APs to be sent to the UE;
logic configured to generate WLAN AP selection assistance information that includes at least (i) the list of WLAN APs and (ii) navigation information by which the UE can navigate to the listed WLAN APs; and
logic configured to transmit the WLAN AP selection assistance information to the UE.

33. A communication entity configured to exchange data between a User Equipment (UE) and a Wireless Wide Area Network (WWAN)-based application server over a Wireless Local Area Network (WLAN), comprising:
logic configured to determine that the UE is connected to a given WLAN access point (AP);
logic configured to calculate an estimated duration that the UE is expected to remain connected to the given WLAN AP; and
logic configured to advertise the UE's connection to the given WLAN AP and information associated with the estimated duration to prompt one or more external entities to exchange an amount of data with the UE that is based on the estimated duration.

34. The communication entity of claim 33, wherein the communication entity corresponds to the UE.

35. The communication entity of claim 33, wherein the communication entity corresponds to the application server.

36. A communication entity configured to exchange data between a User Equipment (UE) and a Wireless Wide Area Network (WWAN)-based application server over a Wireless Local Area Network (WLAN), comprising:
logic configured to receive an advertisement indicating (i) that the UE is connected to a given WLAN AP and (ii) information associated with an estimated duration that the UE is expected to remain connected to the given WLAN AP; and
logic configured to determine whether to transmit one or more files with a size above a threshold based on the received advertisement.

37. The communication entity of claim 36, wherein the communication entity corresponds to a given UE to which the advertisement is directed.

38. The communication entity of claim 36, wherein the communication entity corresponds to the application server.

39. A non-transitory computer-readable medium containing instructions stored thereon, which, when executed by a User Equipment (UE) configured to connect to a Wireless Local Area Network (WLAN) and to exchange data with a Wireless Wide Area Network (WWAN)-based application server, cause the UE to perform operations, the instructions comprising:
program code to monitor a local environment of the UE;
program code to transmit local environment information to the application server based on the monitoring;
program code to receive, in response to the transmission of the local environment information, WLAN AP selection assistance information that includes at least (i) a list of WLAN access points (APs) that are in a vicinity of the UE and (ii) navigation information by which the UE can navigate to the listed WLAN APs;
program code to determine a selection of one of the listed WLAN APs; and
program code to provide a user of the UE with directions to the selected WLAN AP based on the selected WLAN AP's associated navigation information.

40. A non-transitory computer-readable medium containing instructions stored thereon, which, when executed by an application server that is based in a Wireless Wide Area Network (WWAN) and is configured to exchange data with a User Equipment (UE) configured to connect to a Wireless Local Area Network (WLAN), cause the application server to perform operations, the instructions comprising:
program code to receive information indicative of a local environment of the UE;
program code to determine a set of WLAN access points (APs) that are in a vicinity of the UE based on the local environment information;
program code to generate, based on the determined set of WLAN APs, a list of WLAN APs to be sent to the UE;
program code to generate WLAN AP selection assistance information that includes at least (i) the list of WLAN APs and (ii) navigation information by which the UE can navigate to the listed WLAN APs; and
program code to transmit the WLAN AP selection assistance information to the UE.

41. A non-transitory computer-readable medium containing instructions stored thereon, which, when executed by a communication entity configured to exchange data between a User Equipment (UE) and a Wireless Wide Area Network (WWAN)-based application server over a Wireless Local Area Network (WLAN), cause the communication entity to perform operations, the instructions comprising:
program code to determine that the UE is connected to a given WLAN access point (AP);
program code to calculate an estimated duration that the UE is expected to remain connected to the given WLAN AP; and
program code to advertise the UE's connection to the given WLAN AP and information associated with the estimated duration to prompt one or more external entities to exchange an amount of data with the UE that is based on the estimated duration.

42. The non-transitory computer-readable medium of claim 41, wherein the communication entity corresponds to the UE.

43. The non-transitory computer-readable medium of claim 41, wherein the communication entity corresponds to the application server.

44. A non-transitory computer-readable medium containing instructions stored thereon, which, when executed by a communication entity configured to exchange data between a User Equipment (UE) and a Wireless Wide Area Network (WWAN)-based application server over a Wireless Local Area Network (WLAN), cause the communication entity to perform operations, the instructions comprising:
program code to receive an advertisement indicating (i) that the UE is connected to a given WLAN AP and (ii) information associated with an estimated duration that the UE is expected to remain connected to the given WLAN AP; and
program code to determine whether to transmit one or more files with a size above a threshold based on the received advertisement.

45. The non-transitory computer-readable medium of claim 44, wherein the communication entity corresponds to a given UE to which the advertisement is directed.

46. The non-transitory computer-readable medium of claim 44, wherein the communication entity corresponds to the application server.
